(19) United States
(12) Patent Application Publication
(10) Pub. No.: US 2020/0032060 A1
(43) Pub. Date: Jan. 30, 2020

(54) BLENDS OF AROMATIC POLYMERS AND ADDUCTS OBTAINED THEREFROM

(71) Applicant: SOLVAY SPECIALTY POLYMERS USA, LLC, Alpharetta, GA (US)

(72) Inventors: John Scott FLANAGAN, Chamblee, GA (US); Stéphane JEOL, Cumming, GA (US); Kermit S. KWAN, Cumming, GA (US); David KERCHER, Roswell, GA (US); Joel POLLINO, Johns Creek, GA (US); Matthew BOOHER, Cumming, GA (US)

(21) Appl. No.: 16/491,433

(22) PCT Filed: Mar. 6, 2018
(86) PCT No.: PCT/EP2018/055500

§ 371 Date: Sep. 5, 2019

Related U.S. Application Data
(60) Provisional application No. 62/468,187, filed on Mar. 7, 2017.

(30) Foreign Application Priority Data
Apr. 10, 2017 (EP) 17165733.1

(51) Int. Cl. C08L 81/06; C08L 71/12; C08G 75/23; C08G 65/40

(52) U.S. Cl. CPC C08L 81/06; C08L 71/12; C08L 79/08; C08G 65/40; C08G 75/23

(57) ABSTRACT

The present invention relates to polymers and blends of polymers comprising anthracene moieties able to undergo a cycloaddition reaction under certain stimuli, thereby forming polymer adducts endowed with improved or additional properties with respect to those of the starting polymers.

### RELATED APPLICATIONS

This application claims priority to U.S. provisional application No. 62/468,187—filed on Mar. 7, 2017, and to European application No. 17165733.1—filed on Apr. 10, 2017, the whole content of each of these applications being incorporated herein by reference for all purposes.

### TECHNICAL FIELD

The present invention relates to polymers and blends of polymers comprising anthracene moieties able to undergo a cycloaddition reaction under certain stimuli, thereby forming polymer adducts endowed with improved or additional properties with respect to those of the starting polymers.

### BACKGROUND ART

Stimuli-responsive polymers, also called smart polymers, are defined as polymers which can change their properties under specific conditions, for example humidity, pH, UV light or heat. Stimuli-responsive polymers are for example used in drug delivery. As an example, conformational changes in water permeability under acid/basic pH conditions can be exploited to design carriers for drugs to be released at a desired body location. Stimuli-responsive polymers are also used in biomedical engineering. Smart polymers sensitive to UV light can be used, for example, as shape-memory materials for the manufacture of stents, as self-healing materials and for the manufacture of medical implants.

Anthracene moieties and derivatives, are able to undergo cyclization reactions with other moieties, for example, a second anthracene moiety, or a maleimide moiety, under certain stimuli, for example UV light of proper wavelength. Examples of polymers containing anthracene and/or maleimide moieties are polystyrene-g-poly(ethylene glycol) and polystyrene-g-poly(methyl methacrylate) polymers (Gacal et al. Macromolecules 2006, 39, 5330-5336), maleimide-terminated poly (ether sulfone)s (Maes et al., Journal of Polymer Science: Part A, Polymer Chemistry, Vol. 32, 3171-3182, 1994), polylactic acid (Davidson, ACS Appl. Mater. Interfaces, 2016, 8, 16961-16966), poly(methyl acrylate polymers) (Connal, Adv. Funct. Mater., 2008, 18, 3315-3322), polyesters and polyurethanes (Tazuke et al., Journal of Polymer Science: Polymer Chemistry Edition, Vol. 16, 2729-2739), poly(⋅-caprolactone) (Defize et al., Macromol. Chem. Phys., 2012, 213, 187-197) and poly-(ethylene-butyl-acrylate) copolymers (López-Vilanova al., European Polymer Journal 56, 2014, 69-76).

In particular, Maes et al. discloses high temperature poly(ether sulphone)s (HTPES) with various chain-terminating groups, among them maleimide-ended HTPES. Thermal stability is investigated and it is stated that these polymers are expected to undergo cross-linking by free-radical polymerization of the maleimide double bond at high temperatures; such cross-linking would be irreversible and no hint or suggestion to use the polymers as reagents in cycloaddition reactions is given.

High performance aromatic polymers, such as poly(aryl ether ketones) (PAEK) and poly(aryl ether sulfones) (PAES), are used in a variety of applications due to their good processability, good chemical and hydrolysis resistance, high service temperatures (Tg higher than 140° C.), high thermal stability (generally no more than 5 wt.-% degradation under nitrogen at temperatures higher than 400° C.) and good mechanical properties.

In view of their high content of aromatic moieties, one would expect that the exposure of PAEK, PAES, PAEI and PCA to UV light would lead to high UV light absorption that would significantly degrade the polymer. Furthermore, according to the teaching of Maes, C. et al., one would expect that aromatic polyaryl ethers containing maleimide moieties would undergo thermally activated irreversible reactions.

### SUMMARY OF INVENTION

The present invention relates to a blend comprising at least two distinct polymers selected from the group consisting of:
at least one polymer (P1) comprising recurring units (RP1) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moiety (M1):

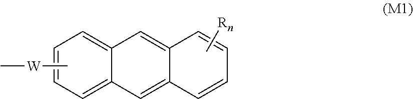

wherein:
   W is a bond, O, C(O), S, SO₂, C(O)NH, C(O)O, O—C(O)—O, NH—C(O)NH—, NH—C(O)—O, an imine-containing moiety or an imide-containing moiety;
   R is a halogen atom or an alkyl group, optionally branched, preferably an C1-C18 alkyl group optionally substituted with one or several halogen atoms; and
   n is 0 or an integer from 1 to 9, preferably 0; and
optionally at least one polymer (P2) comprising recurring units (R_{P2}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least moiety (M2a) or (M2b):

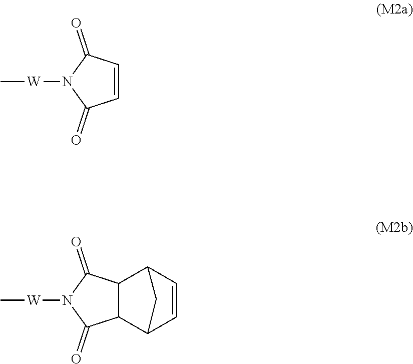

wherein:
W is a bond, O, C(O), S, SO₂, C(O)NH, C(O)O, O—C(O)—O, NH—C(O)NH—, NH—C(O)—O, an imine-containing moiety or an imide-containing moiety.

The present invention also relates to a polymer adduct obtained by exposing to UV light at a wavelength ranging from 300 nm to 600 nm, preferably from 350 nm to 400 nm:
a polymer (P1) comprising recurring units (R_{P1}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moiety (M1):

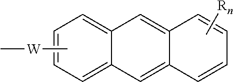

wherein:
W is a bond, O, C(O), S, SO₂, C(O)NH, C(O)O, O—C(O)—O, NH—C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; or
the blend of the present invention

The present invention further relates to a polymer adduct obtained by heating at a temperature ranging from 60° C. to 250° C., preferably from 65° C. to 200° C., the blend of the present invention.

The present invention relates to a method for coating a surface, comprising:

a) applying to the surface:
a polymer (P1) comprising recurring units (R_{P1}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moiety (M1):

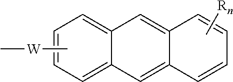

wherein:
W is a bond, O, C(O), S, SO₂, C(O)NH, C(O)O, O—C(O)—O, NH—C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; and
the blend of the present invention,
   optionally in combination with one or more solvents and/or additives,
   b) irradiating the surface at a wavelength ranging from 300 nm to 600 nm, preferably from 350 nm to 400 nm, or
   b′) heating the surface at a temperature ranging from 60° C. to 250° C., preferably from 65° C. to 200° C.

The present invention relates to a method for manufacturing a formed article, comprising:

a) applying to a mould:
a polymer (P1) comprising recurring units (R_{P1}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moeity (M1):

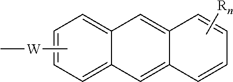

wherein:
W is a bond, O, C(O), S, SO₂, C(O)NH, C(O)O, O—C(O)—O, NH—C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; and
the blend of the present invention,
   optionally in combination with one or more solvents and/or additives,
   b) irradiating the mould at a wavelength ranging from 300 nm to 600 nm, preferably from 350 nm to 400 nm, or
   b′) heating the mould at a temperature ranging from 60° C. to 250° C., preferably from 65° C. to 200° C.

The present invention relates to a method for recycling a coating or a formed article, comprising the polymer adduct obtained by exposing a polymer (P1) to UV light at a wavelength ranging from 300 nm to 600 nm, wherein polymer (P1) comprises recurring units (RP1) selected from the group consisting of poly(aryl ether sulfone) (PAES), poly(aryl ether ketone) (PAEK), poly(ether imide) (PEI) and polycarbonate (PC) and comprising at least one moiety (M1):

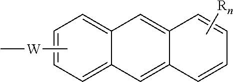

wherein:
   W is a bond, O, C(O), S, SO₂, C(O)NH, C(O)O, O—C(O)—O, NH—C(O)NH—, NH—C(O)—O, an imine-containing moiety or an imide-containing moiety;
   R is a halogen atom or an alkyl group, optionally branched, preferably an C1-C18 alkyl group optionally substituted with one or several halogen atoms; and
   n is 0 or an integer from 1 to 9, preferably 0; or
      wherein the method comprises submitting the coating or formed article to UV irradiation at a wavelengths lower than 300 nm.

A method for recycling a coating or a formed article, comprising the polymer adduct of the present invention, by submitting the coating or formed article to heating at a temperature ranging from 100° C. to 500° C.

The present invention also relates to a recycled material obtainable by the recycling methods of the present invention.

The present invention further relates to a polymer (P1) comprising:
recurring units (R_{PPSU}) of formula (L-A):

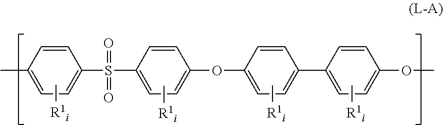

at least one moiety (M1):

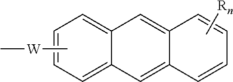

wherein:
each R¹ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is an integer independently selected from 0 to 4;
W is O, C(O), S, SO₂, C(O)NH, C(O)O, O—C(O)—O, NH—C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; and

### DESCRIPTION OF EMBODIMENTS

Aromatic polymers (P1) of the present invention, comprising recurring units (R_{P1}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moiety (M1):

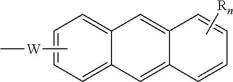

wherein:
W is a bond, O, C(O), S, SO₂, C(O)NH, C(O)O, O—C(O)—O, NH—C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; and
   can be effectively UV cured, in the form of blends with, for example, one distinct polymer (P1), to form polymer adducts via cycloaddition reaction between moieties (M1).

Aromatic polymers (P1) of the present invention can also be blended with one or more aromatic polymers (P2), these polymers (P2) comprising recurring units (R_{P2}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moiety (M2a) or (M2b):

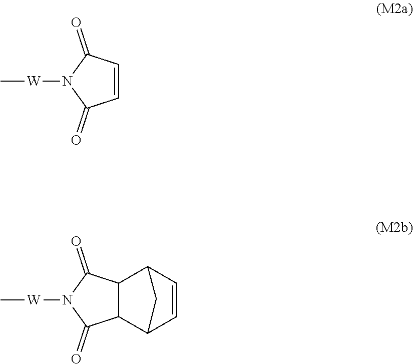

wherein:
W is a bond, O, C(O), S, SO₂, C(O)NH, C(O)O, O—C(O)—O, NH—C(O)NH—, NH—C(O)—O, an imine-containing moiety or an imide-containing moiety.

The blend of at least one polymer (P1) and at least one polymer (P2) can be submitted to thermal curing to form polymer adducts via cycloaddition reaction between moieties (M1) and (M2a)/(M2b).

The formation of adducts is reversible under certain light/temperature stimuli; therefore such adducts qualify as stimuli-responsive polymers and can be effectively used in applications in which it is important to adapt the polymer structure to specific conditions. The reversibility can also be exploited to recycle any formed articles obtained from the adducts. In coating applications, the formation of adducts offers the advantage to provide coatings that can be easily repaired by self-healing.

In addition, the formation of adducts represents a convenient way of obtaining high molecular weight polymeric structures, i.e. adducts from polymers of lower molecular weight, in the melt or in solution phase. It also represents a convenient way to obtain high molecular weight polymeric structures without rearrangement and randomization of the polymer repeat units, because the formation of adducts occurs under mild conditions.

Therefore, the present invention relates to blends, to adducts and to formed articles obtained from such mixtures and blends. It also relates to methods of manufacturing said articles and to methods of recycling said articles.

According to the present invention, polymers (P1) comprise:
a polymer chain (PC-1) comprising recurring units (R_{P1}) selected from the group consisting of (R_{PAES}), (R_{PAEK}), (R_{PAI}), (R_{PP}), (R_{PEI}) and (R_{PC}), and
at least one moiety (M1):
   at one or both ends of the polymer chain (PC-1), and/or
   as pendant group along the polymer chain (PC-1), and/or
   included in the polymer chain (PC-1).

According to one embodiment, aromatic polymers (P1) of the present invention comprise recurring units (R_{P1}) and at least one moiety (M1) at one end of the polymer chain (PC-1) (or in other words as a terminal group of the polymer P1), preferably moieties (M1) at both ends of the polymer chain (PC-1).

The amount of polymer units comprising (M1) in P1 can range from 0.1 to 100 mol. %, from 0.5 to 25 mol. %, or from 1 to 15 mol. %, based on the total number of recurring units in the polymer (P1).

According to the present invention, polymers (P2) comprise:
a polymer chain (PC-2) comprising recurring units (R_{P2}) selected from the group consisting of (R_{PAES}), (R_{PAEK}), (R_{PAI}), (R_{PP}), (R_{PEI}) and (R_{PC}), this polymer chain having two ends, and
at least one moiety (M2a) or (M2b):
   at one or both ends of the polymer chain (PC-2), and/or
   as pendant group along the polymer chain (PC-2), and/or
   included in the polymer chain (PC-2).

According to one embodiment, polymers (P2) of the present invention comprise recurring units (R_{P2}) and at least one moiety (M2a) or (M2b) at one end of the polymer chain (PC-2) (or in other words as a terminal group of the polymer P2), preferably moieties (M2a) or (M2b) at both ends of the polymer chain (PC-2).

The amount of polymer units comprising (M2a) or (M2b) in P2 can range from 0.1 to 100 mol. %, from 0.5 to 25 mol. %, or from 1 to 15 mol. %, based on the total number of recurring units in the polymer (P2).

According to an embodiment, the moiety (M1) is selected from the group consisting of formulas (M1-a)-(M1-d) below:

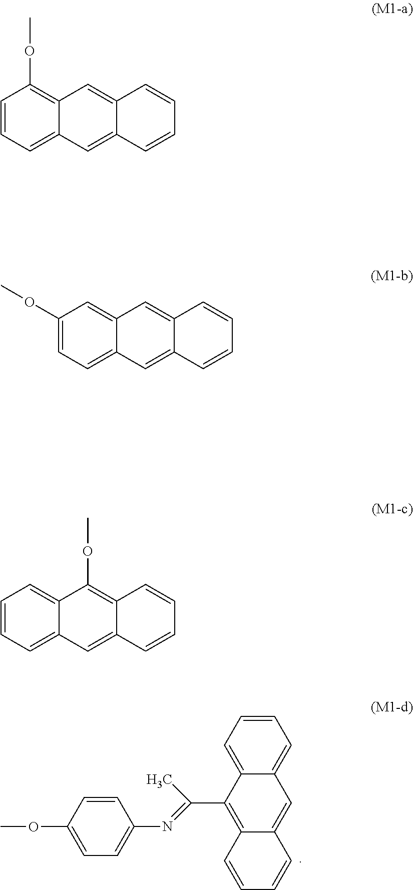 [SMILES: COc1cccc2cc3ccccc3cc12 ; COc1ccc2cc3ccccc3cc2c1 ; COc1c2ccccc2cc2ccccc12 ; COc1ccc(/N=C(\C)c2c3ccccc3cc3ccccc23)cc1]

According to an embodiment, the moiety (M1) is according to formula (M1-e) below:

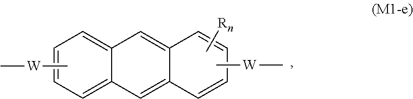

wherein W, R and n are as above-defined,
or according to any of formulas (M1-ea)-(M1-ed) below:

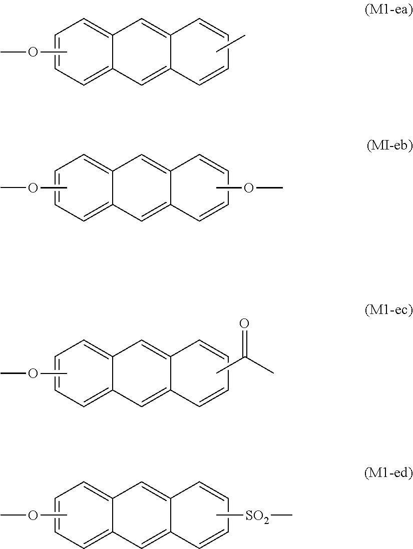

Polymers P1 and/or P2 can be prepared by methods known in the art.

Polymer P1 can notably be prepared staring from polymers selected from the group consisting of PAES having recurring units (R_{PAES}), PAEK having recurring units (R_{PAEK}), PAI having recurring units (R_{PAI}), PP having recurring units (R_{PP}), PEI having recurring units (R_{PEI}) and PC having recurring units (R_{PC}), then by attaching anthracene moieties selected having one or more functional groups capable of reacting with the polymer end groups, or with sites along the polymer backbone. As an alternative approach, polymers selected from the group consisting of PAES having recurring units (R_{PAES}), PAEK having recurring units (R_{PAEK}), PAI having recurring units (R_{PAI}), PP having recurring units (R_{PP}), PEI having recurring units (R_{PEI}) and PC having recurring units (R_{PC}) methods may be altered by the addition of anthracene moieties having two or more functional groups capable of participating in the polymerization reaction such that the anthracene moiety becomes incorporated into the polymer chain.

Polymers P2 is by the reaction of cyclic acid anhydrides such as maleic anhydride with polymers having primary amines as end groups or as pendant groups to form maleimide groups end groups or pendant groups.

According to an embodiment of the present invention, P1 and/or P2 has a number average molecular weight (Mn) of less than about 25,000 g/mol, less than about 18,000 g/mol, or less than about 10,000 g/mol, as measured by gel permeation chromatography (GPC) using the appropriate method based on the chemistry of the polymer chain. For PAES polymer notably, methylene chloride is used as a mobile phase, with polystyrene standards. For PAEK, phenol and trichlorobenzene (1:1) at 160° C. are used, with polystyrene standards.

According to an embodiment of the present invention, P1 and/or P2 has a number average molecular weight (Mn) of no less than about 1,000 g/mol or no less than about 2,000 g/mol, as measured by gel permeation chromatography (GPC).

### Blends

The present invention relates to blends comprising at least two distinct polymers (P1) or comprising at least one aromatic polymer (P1) and at least one aromatic polymer (P2). Aromatic polymers (P1) and (P2) of the present invention comprise recurring units selected from the group consisting of poly(aryl ether sulfone) (PAES) recurring units (R_{PAES}), poly(aryl ether ketone) (PAEK) recurring units (R_{PAEK}), poly(amide imide) (PAI) recurring units (R_{PAI}), polyphenylene (PP) recurring units (R_{PP}), poly(ether imide) (PEI) recurring units (R_{PEI}) and polycarbonate (PC) recurring units (R_{PC}).

According to an embodiment, the blend of the present invention comprises at least two distinct polymers (P1), which both comprise PAES recurring units (R_{PAES}).

According to an embodiment, the blend of the present invention comprises at least one polymer (P1) and at least one polymer (P2), which both comprise PAES recurring units (R_{PAES}).

Poly(aryl ether sulfone) (PAES)

According to an embodiment of the present invention, P1 and/or P2 are poly(aryl ether sulfone) (PAES) polymers as below defined. In other words, according to this embodiment, P1 and/or P2 comprise PAES recurring units (R_{PAES}).

According to an embodiment of the present invention, P1 and/or P2 comprises recurring units (R_{PAES}) of formula (L):

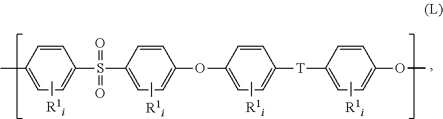

wherein
each R¹ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is an independently selected integer from 0 to 4;
T is selected from the group consisting of a bond, —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ— with m being an integer from 1 to 6; an aliphatic divalent group, linear or branched, of up to 6 carbon atoms; and combinations thereof.

According to an embodiment, R¹ is, at each location in formula (L) above, independently selected from the group consisting of a C1-C12 moiety optionally comprising one or more than one heteroatoms; sulfonic acid and sulfonate groups; phosphonic acid and phosphonate groups; amine and quaternary ammonium groups.

According to an embodiment, i is zero for each R¹ or formulas (L). In other words, according to this embodiment, the recurring units (R_{PAES}) may be units of formula (L′):

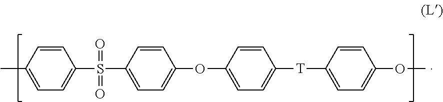

According to another embodiment of the present invention, P1 and/or P2 comprises at least 50 mol. % (based on the total number of moles in the polymer) of recurring units of formula (L) and/or (L′).

According to another embodiment of the present invention, at least 60 mol. %, at least 70 mol. %, at least 80 mol. %, at least 90 mol. %, at least 95 mol. %, at least 99 mol. % or all of the recurring units in P1 and/or P2 are recurring units (R_{PAES}) of formula (L) or formula (L′).

According to an embodiment, P1 and/or P2 of the present invention has a Tg ranging from 120 and 250° C., preferably from 170 and 240° C., more preferably from 180 and 230° C., as measured by differential scanning calorimetry (DSC) according to ASTM D3418.

According to an embodiment of the present invention, P1 and/or P2 is such that T is selected from the group consisting of a bond, —SO₂— and —C(CH₃)₂—.

According to yet another embodiment of the present invention, P1 and/or P2 comprises at least 50 mol. % (based on the total number of moles in the polymer) of recurring units selected from the group consisting of formulas:

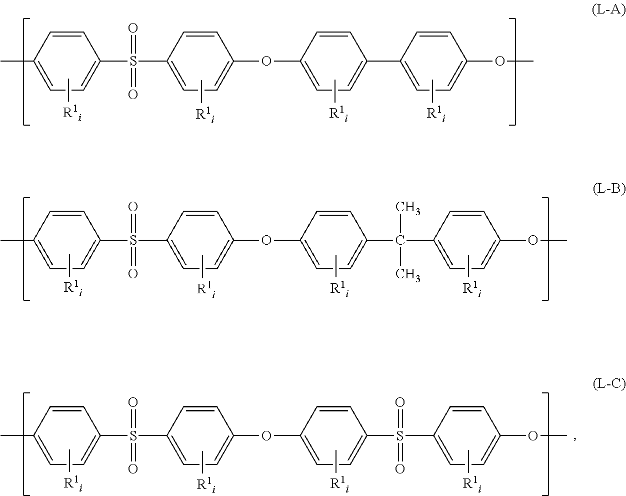

wherein R1 and i are as above-mentioned.

According to yet another embodiment of the present invention, P1 and/or P2 comprises at least 50 mol. % (based on the total number of moles in the polymer) of recurring units selected from the group consisting of formulas (L-A), (L-B) and (L-C), wherein i is zero for each R¹.

Polymer P1 of the present invention also comprises at least one moiety (M1), as above defined.

Polymer P2 of the present invention also comprises at least one moiety (M2a) or (M2b).

According to an embodiment of the present invention, P1 and/or P2 comprises at least 50 mol. % (based on the total number of moles in the polymer) of recurring units (R_{PPSU}) of formulas (L-A) or (L-A′) wherein i is zero for each R¹; for example according to this embodiment, P1 and/or P2 comprises at least 60 mol. %, at least 70 mol. %, at least 80 mol. %, at least 90 mol. %, at least 95 mol. %, at least 99 mol. % of recurring units (R_{PPSU}) of formula (L-A) or formula (L-A′). According to another embodiment, all of the recurring units in P1 and/or P2 are recurring units (R_{PPSU}) of formulas (L-A) or (L-A′) wherein i is zero for each R¹.

According to an embodiment of the present invention, P1 and/or P2 is a poly(biphenyl ether sulfone) polymer (PPSU), that-is-to-say a polyarylene ether sulfone which comprises a biphenyl moiety. Poly(biphenyl ether sulfone) is also known as polyphenyl sulfone (PPSU) and for example results from the condensation of 4,4′-dihydroxybiphenyl (biphenol) and 4,4′-dichlorodiphenyl sulfone. The poly(biphenyl ether sulfone) (PPSU) can be prepared by any method known in the art. It can for example result from the condensation of 4,4′-dihydroxybiphenyl (biphenol) and 4,4′-dichlorodiphenyl sulfone in presence of a base. The reaction of monomer units takes place through nucleophilic aromatic substitution with the elimination of one unit of hydrogen halide as leaving group. It is to be noted however that the structure of the resulting poly(biphenyl ether sulfone) does not depend on the nature of the leaving group.

PPSU is commercially available as Radel® PPSU from Solvay Specialty Polymers USA, L.L.C.

According to an embodiment of the present invention, P1 and/or P2 comprises at least 50 mol. % (based on the total number of moles in the polymer) of recurring units (R_{PSU}) of formulas (L-B) or (L-B′) wherein i is zero for each R¹; for example according to this embodiment, P1 and/or P2 comprises at least 60 mol. %, at least 70 mol. %, at least 80 mol. %, at least 90 mol. %, at least 95 mol. %, at least 99 mol. % of recurring units (R_{PSU}) of formula (L-B) or formula (L-B′). According to another embodiment, all of the recurring units in P1 and/or P2 are recurring units (R_{PSU}) of formulas (L-B) or (L-B′) wherein i is zero for each R¹.

PSU is available as Udel® PSU from Solvay Specialty Polymers USA, L.L.C.

According to an embodiment of the present invention, P1 and/or P2 comprises at least 50 mol. % (based on the total number of moles in the polymer) of recurring units (R_{PES}) of formulas (L-C) or (L-C′) wherein i is zero for each R¹; for example according to this embodiment, P1 and/or P2 comprises at least 60 mol. %, at least 70 mol. %, at least 80 mol. %, at least 90 mol. %, at least 95 mol. %, at least 99 mol. % of recurring units (R_{PES}) of formula (L-C) or formula (L-C′). According to another embodiment, all of the recurring units in the P1 and/or P2 are recurring units (R_{PES}) of formulas (L-C) or (L-C′) wherein i is zero for each R¹.

PES is available as Veradel® PES from Solvay Specialty Polymers USA, L.L.C.

According to a preferred embodiment, polymer (P1) is a poly(aryl ether sulfone) (PAES) polymer (P1) consisting essentially in:

1/ recurring units (R_{PAES}) of formula (L):

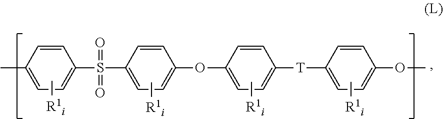

2/ one or two terminal groups of formula (M1), as above defined,
wherein:
each R¹ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is an independently selected integer from 0 to 4;
T is selected from the group consisting of a bond, —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ— with m being an integer from 1 to 6; an aliphatic divalent group, linear or branched, of up to 6 carbon atoms; and combinations thereof.

According to this embodiment, P1 is made exclusively of recurring units (R_{PAES}) of formula (L) and comprises one or two terminal groups of formula (M1).

According to another preferred embodiment, polymer (P1) is a poly(aryl ether sulfone) (PAES) polymer (P1) consisting essentially in:

1/ recurring units (R_{PAES}) of formula (L-A), (L-B) or (L-C) and
2/ one or two terminal groups of formula (M1).

Preferably according to this embodiment, i is zero for each R¹.

Poly(aryl ether ketone) (PAEK)

According to an embodiment of the present invention, P1 and/or P2 are poly(aryl ether ketone) (PAEK) polymers as below defined. In other words, according to this embodiment, P1 and/or P2 comprise PAEK recurring units (R_{PAEK}).

According to an embodiment of the present invention, P1 and/or P2 comprises recurring units (R_{PAEK}) comprising a Ar′—C(═O)—Ar* group, where Ar′ and Ar*, equal to or different from each other, are aromatic groups, the mol. % being based on the total number of moles of recurring units in the polymer. The recurring units (R_{PAEK}) are selected from the group consisting of units of formulas (J-A) to (J-D) below:

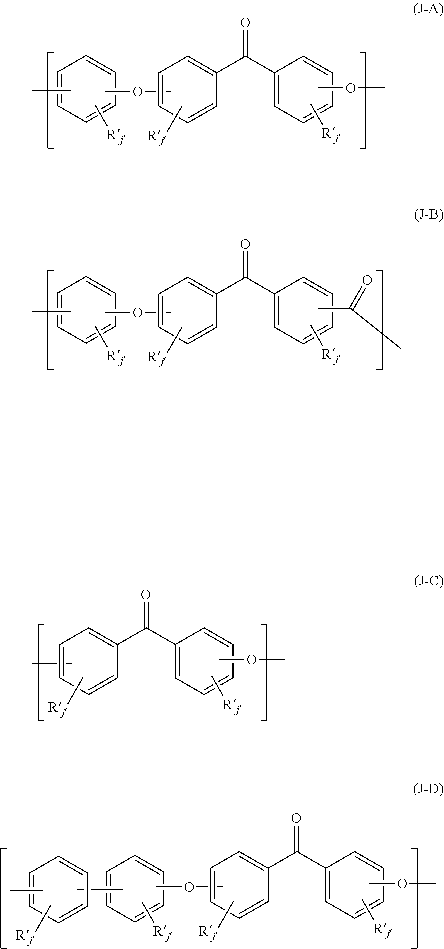

where
R′, at each location, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j′ is independently zero or an integer ranging from 1 to 4.

In recurring unit (R_{PAEK}), the respective phenylene moieties may independently have 1,2-, 1,4- or 1,3-linkages to the other moieties different from R′ in the recurring unit (R_{PAEK}). Preferably, the phenylene moieties have 1,3- or 1,4-linkages, more preferably they have a 1,4-linkage.

In recurring units (R_{PAEK}), j′ is preferably at each location zero so that the phenylene moieties have no other substituents than those linking the main chain of the polymer.

According to an embodiment, P1 and/or P2 is a poly(ether ether ketone) (PEEK).

As used herein, a poly(ether ether ketone) (PEEK) denotes any polymer comprising recurring units (R_{PEEK}) of formula (J-A), based on the total number of moles of recurring units in the polymer:

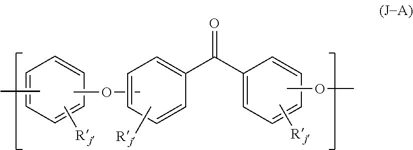

where
R′, at each location, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j′, for each R′, is independently zero or an integer ranging from 1 to 4 (for example 1, 2, 3 or 4).

According to formula (J-A), each aromatic cycle of the recurring unit (R_{PEEK}) may contain from 1 to 4 radical groups R′. When j′ is O, the corresponding aromatic cycle does not contain any radical group R′.

Each phenylene moiety of the recurring unit (R_{PEEK}) may, independently from one another, have a 1,2-, a 1,3- or a 1,4-linkage to the other phenylene moieties. According to an embodiment, each phenylene moiety of the recurring unit (R_{PEEK}), independently from one another, has a 1,3- or a 1,4-linkage to the other phenylene moieties. According to another embodiment yet, each phenylene moiety of the recurring unit (R_{PEEK}) has a 1,4-linkage to the other phenylene moieties.

According to an embodiment, R′ is, at each location in formula (J-A) above, independently selected from the group consisting of a C1-C12 moiety, optionally comprising one or more than one heteroatoms; sulfonic acid and sulfonate groups; phosphonic acid and phosphonate groups; amine and quaternary ammonium groups.

According to an embodiment, j′ is zero for each R′. In other words, according to this embodiment, the recurring units (R_{PEEK}) are according to formula (J′-A):

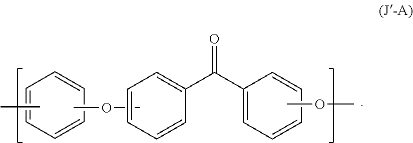

According to another embodiment of the present disclosure, a poly(ether ether ketone) (PEEK) denotes any polymer comprising at least 10 mol. % of the recurring units are recurring units (R_{PEEK}) of formula (J-A″):

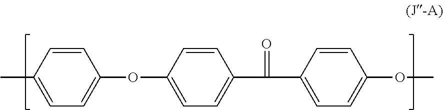

the mol. % being based on the total number of moles of recurring units in the polymer.

According to an embodiment of the present disclosure, at least 10 mol. % (based on the total number of moles of recurring units in the polymer), at least 20 mol. %, at least 30 mol. %, at least 40 mol. %, at least 50 mol. %, at least 60 mol. %, at least 70 mol. %, at least 80 mol. %, at least 90 mol. %, at least 95 mol. %, at least 99 mol. % or all of the recurring units in the PEEK are recurring units (R_{PEEK}) of formulas (J-A), (J′-A) and/or (J″-A).

The PEEK polymer can therefore be a homopolymer or a copolymer. If the PEEK polymer is a copolymer, it can be a random, alternate or block copolymer.

When P1 and/or P2 is a PEEK copolymer, it can be made of recurring units (R*_{PEEK}), different from and in addition to recurring units (R_{PEEK}), such as recurring units of formula (J-D):

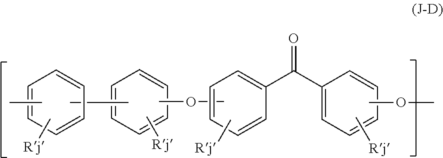

where
   R′, at each location, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
   j′, for each R′, is independently zero or an integer ranging from 1 to 4.

According to formula (J-D), each aromatic cycle of the recurring unit (R*_{PEEK}) may contain from 1 to 4 radical groups R′. When j′ is 0, the corresponding aromatic cycle does not contain any radical group R′.

According to an embodiment, R′ is, at each location in formula (J-B) above, independently selected from the group consisting of a C1-C12 moiety, optionally comprising one or more than one heteroatoms; sulfonic acid and sulfonate groups; phosphonic acid and phosphonate groups; amine and quaternary ammonium groups.

According to an embodiment, j′ is zero for each R′. In other words, according to this embodiment, the recurring units (R*_{PEEK}) are according to formula (J′-D):

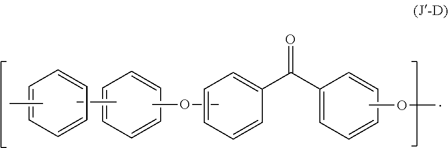

According to another embodiment of the present disclosure, the recurring units (R*_{PEEK}) are according to formula (J″-D):

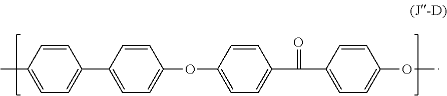

According to an embodiment of the present disclosure, less than 90 mol. % (based on the total number of moles of recurring units in the polymer), less than 80 mol. %, less than 70 mol. %, less than 60 mol. %, less than 50 mol. %, less than 40 mol. %, less than 30 mol. %, less than 20 mol. %, less than 10 mol. %, less than 5 mol. %, less than 1 mol. % or all of the recurring units in P1 and/or P2 are recurring units (R*_{PEEK}) of formulas (J-B), (J′-B), and/or (J″-B).

According to an embodiment, P1 and/or P2 is a PEEK-PEDEK copolymer. As used herein, a PEEK-PEDEK copolymer denotes a polymer comprising recurring units (R_{PEEK}) of formula (J-A), (J′-A) and/or (J″-A) and recurring units (R_{PEEK}) of formulas (J-B), (J′-B) or (J″-B) (also called hereby recurring units (R_{PEDEK})). The PEEK-PEDEK copolymer may include relative molar proportions of recurring units (R_{PEEK}/R_{PEDEK}) ranging from 95/5 to 5/95, from 90/10 to 10/90, or from 85/15 to 15/85. The sum of recurring units (R_{PEEK}) and (R_{PEDEK}) can for example represent at least 60 mol. %, 70 mol. %, 80 mol. %, 90 mol. %, 95 mol. %, 99 mol. %, of recurring units in the PEEK copolymer. The sum of recurring units (R_{PEEK}) and (R_{PEDEK}) can also represent 100 mol. %, of recurring units in the PEEK copolymer.

Defects, end groups and monomers' impurities may be incorporated in very minor amounts in the polymer (PEEK) of the present disclosure, without undesirably affecting the performance of the polymer in the polymer composition (C1).

PEEK is commercially available as KetaSpire® PEEK from Solvay Specialty Polymers USA, LLC.

PEEK can be prepared by any method known in the art. It can for example result from the condensation of 4,4′-difluorobenzophenone and hydroquinone in presence of a base. The reaction of monomer units takes place through a nucleophilic aromatic substitution. The molecular weight (for example the weight average molecular weight Mw) can be adjusting the monomers molar ratio and measuring the yield of polymerisation (e.g. measure of the torque of the impeller that stirs the reaction mixture).

In another embodiment, P1 and/or P2 is a poly(ether ketone ketone) (PEKK).

As used herein, a poly(ether ketone ketone) (PEKK) denotes a polymer comprising more than 50 mol. % of the recurring units of formulas (J-B₁) and (J-B₂), the mol. % being based on the total number of moles of recurring units in the polymer:

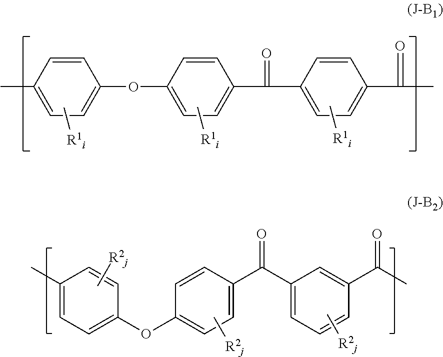

wherein
R¹ and R², at each instance, is independently selected from the group consisting of an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
i and j, at each instance, is an independently selected integer ranging from 0 to 4.

According to an embodiment, R¹ and R² are, at each location in formula (J-B₂) and (J-B₁) above, independently selected from the group consisting of a C1-C12 moiety, optionally comprising one or more than one heteroatoms; sulfonic acid and sulfonate groups; phosphonic acid and phosphonate groups; amine and quaternary ammonium groups.

According to another embodiment, i and j are zero for each R¹ and R² group. According to this embodiment, P1 and/or P2 comprises at least 50 mol. % of recurring units of formulas (J′-B₁) and (J′-B₂), the mol. % being based on the total number of moles of recurring units in the polymer:

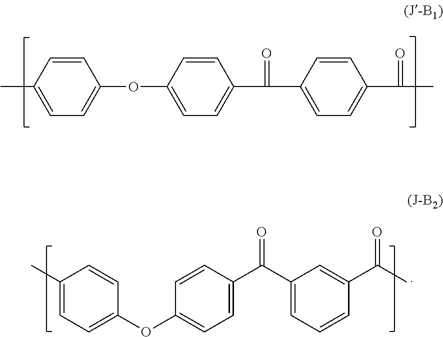

According to an embodiment of the present disclosure, at least 55 mol. %, at least 60 mol. %, at least 70 mol. %, at least 80 mol. %, at least 90 mol. %, at least 95 mol. %, at least 99 mol. % or all of the recurring units in P1 and/or P2 are recurring units of formulas (J-B₁) and (J-B₂).

According to an embodiment of the present disclosure, in P1 and/or P2, the molar ratio of recurring units (J-B₂) or/and (J′-B₂) to recurring units (J-B₁) or/and (J′-B₁) is at least 1:1 to 5.7:1, for example at least 1.2:1 to 4:1, at least 1.4:1 to 3:1 or at least 1.4:1 to 1.86:1.

PEKK is commercially available as NovaSpire® PEKK from Solvay Specialty Polymers USA, LLC

### Polyamideimide (PAI)

According to an embodiment of the present invention, P1 and/or P2 are polyamideimide (PAI) polymers as below defined. In other words, according to this embodiment, P1 and/or P2 comprise PAI recurring units (R_{PAI}).

According to an embodiment of the present invention, P1 and/or P2 comprises at least 50 mol. % of recurring units (R_{PAI}) comprising at least one aromatic ring, at least one imide group, as such and/or in its amic acid form, and at least one amide group which is not included in the amic acid form of an imide group.

The recurring units (R_{PAI}) can be chosen among formulas:

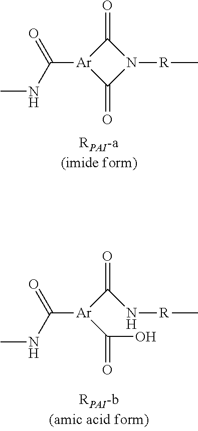

wherein:
Ar is a trivalent aromatic group and can be selected from the group consisting of structures:

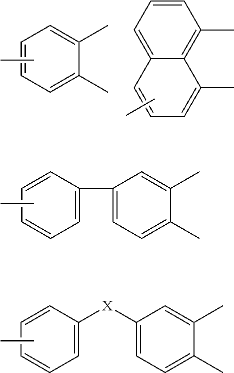

and corresponding optionally substituted structures, with X being —O—, —C(O)—, —CH₂—, —C(CH₃)₂—, —C(CF₃)₂—, —(CF₂)q-, with q being an integer from 1 to 5;
R is a divalent aromatic group and can be selected from the group consisting of following structures:

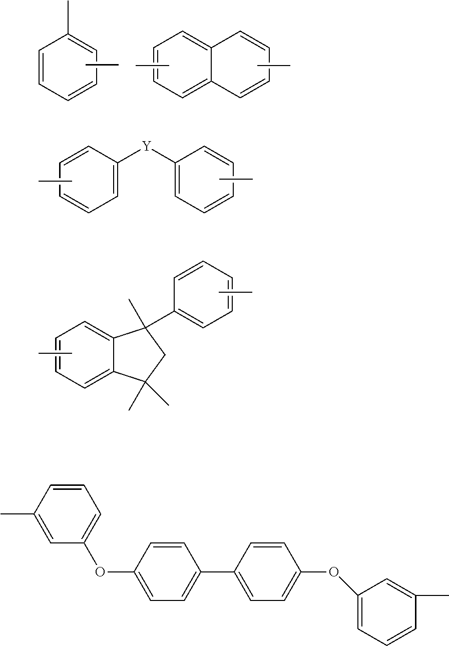

and corresponding optionally substituted structures, with Y being —O—, —S—, —SO₂—, —CH₂—, —C(O)—, —C(CH₃)₂—, —C(CF₃)₂—, —(CF₂)_{q}, q being an integer from 1 to 5.

Preferably, the aromatic polyamide-imide comprises more than 50% of recurring units (R_{PAI}) comprising an imide group in which the imide group is present as such, like in recurring units (R_{PAI}-a), and/or in its amic acid form, like in recurring units (R_{PAI}-b).

Recurring units (R_{PAI}) can be selected from the group consisting of recurring units (I), (m) and (n), in their amide-imide (a) or amide-amic acid (b) forms:

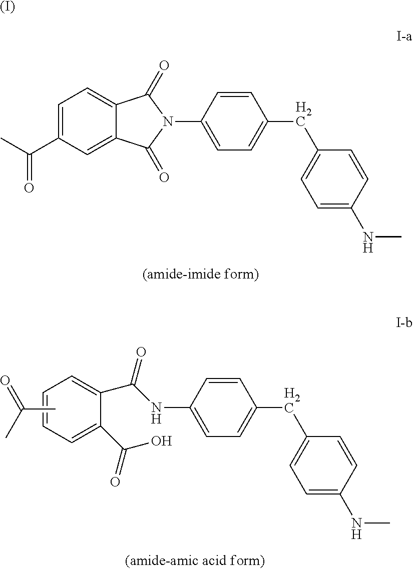

wherein the attachment of the two amide groups to the aromatic ring as shown in (I-b) will be understood to represent the 1,3 and the 1,4 polyamide-amic acid configurations;

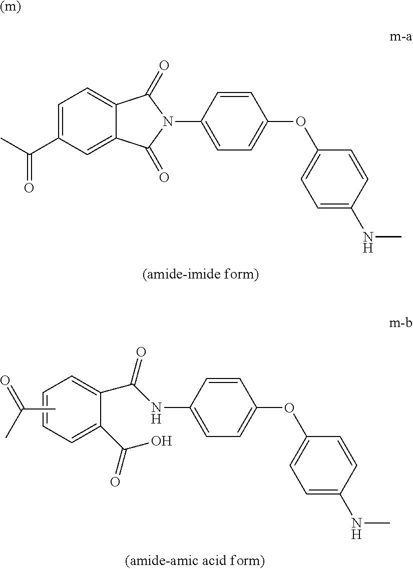

wherein the attachment of the two amide groups to the aromatic ring as shown in (m-b) will be understood to represent the 1,3 and the 1,4 polyamide-amic acid configurations; and

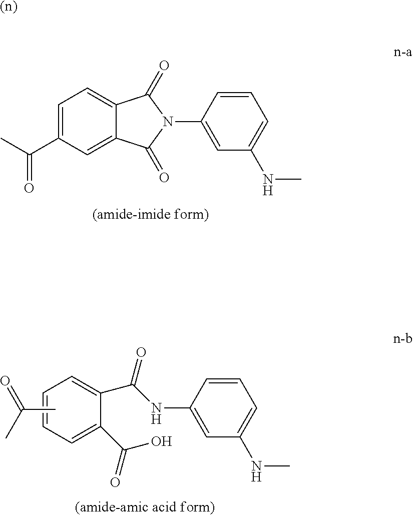

wherein the attachment of the two amide groups to the aromatic ring as shown in (n-b) will be understood to represent the 1,3 and the 1,4 polyamide-amic acid configurations.

According to an embodiment of the present invention, the PAI polymer (P1) or (P2) comprises at least 60 mol. %, at least 70 mol. %, at least 80 mol. %, at least 90 mol. %, at least 95 mol. %, at least 99 mol. % of recurring units (R_{PAI}).

According to an embodiment of the present invention, the PAI polymer (P1) or (P2) contains no recurring unit other than recurring units (R_{PAI}).

PAI polymers are commercially available from Solvay Specialty Polymers USA, L.L.C. as TORLON® polyamide-imides, for example Torlon® 4000T.

### Polyphenylene (PP)

According to an embodiment of the present invention, P1 and/or P2 are polyphenylene (PP) polymers, as below defined. In other words, according to this embodiment, P1 and/or P2 comprise PP recurring units (R_{PP}).

According to an embodiment of the present invention, P1 and/or P2 comprises at least 50 mol. % of recurring units (R_{PP}). of formula (F):

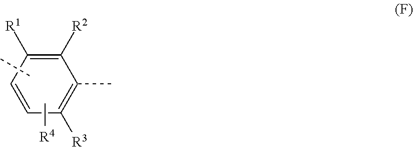

wherein R¹, R², R³, and R⁴ are each independently selected from the group consisting of a hydrogen, an alkyl, an aryl, an alkoxy, an aryloxy, an alkylketone, an arylketone, a fluoroalkyl, a fluoroaryl, a bromoalkyl, a bromoaryl, a chloroalkyl, a chloroaryl, an alkylsulfone, an arylsulfone, an alkylamide, an arylamide, an alkylester, an arylester, a fluorine, a chlorine, and a bromine.

In some embodiments, P1 and/or P2 comprises at least about 60 mol. %, at least about 70 mol. %, at least about 80 mol. %, at least about 90 mol. %, at least about 95 mol. %, at least about 99 mol. % or at least about 99.5 mol. % repeat units (R_{PP}).

In some embodiments, one or more of R¹, R², R³, and R⁴ is independently according to formula (F′):

Ar-Q-(F′)

wherein
Ar is selected from the following group of formulas:

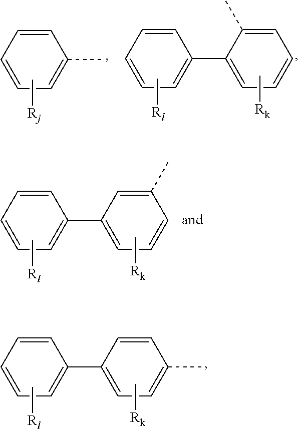

each Rj, Rk and Rl is independently selected from the group consisting of hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and with j and l, equal or different from each other are independently 0, 1, 2, 3, 4, or 5 and, k, equal or different from j or l, is independently 0, 1, 2, 3 or 4;
the dashed lined indicates a bond to T;
Q is selected from the group consisting of —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —RaC═CRb—, where each Ra and Rb, independently of one another, is a hydrogen or a C1-C12-alkyl, C1-C12-alkoxy, or C6-C18-aryl group; —(CH₂)n- and —(CF2)n- with n being an integer from 1 to 6; an aliphatic divalent group, linear or branched, of up to 6 carbon atoms; and combinations thereof.

In some embodiments, one or more of R¹, R², R³, and R⁴ is according to formula (F″):

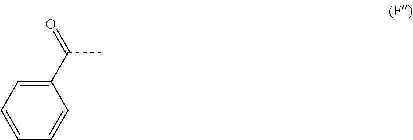

wherein the dashed bond indicates the bond to the benzyl moiety of repeat unit (R_{PP}).

Polyphenylene polymers are commercially available from Solvay Specialty Polymers USA, L.L.C. as PRIMOSPIRE® PR-120 polyphenylene and PRIMOSPIRE® SRP PR-250 polyphenylene.

Poly(ether imide) (PEI)

According to an embodiment of the present invention, P1 and/or P2 is a poly(ether imide) (PEI) polymer as below defined. In other words, according to this embodiment, P1 and/or P2 comprise PEI recurring units (R_{PEI}).

According to an embodiment of the present invention, P1 and/or P2 comprises at least 50 mol. %, based on the total number of moles in the polymer, of recurring units (R_{PEI}) comprising at least one aromatic ring, at least one imide group, as such and/or in its amic acid form, and at least one ether group. Recurring units (R_{PEI}) may optionally further comprise at least one amide group which is not included in the amic acid form of an imide group.

According to an embodiment, the recurring units (R_{PEI}) are selected from the group consisting of following formulas (I), (II), (III), (IV), (V) and mixtures thereof:

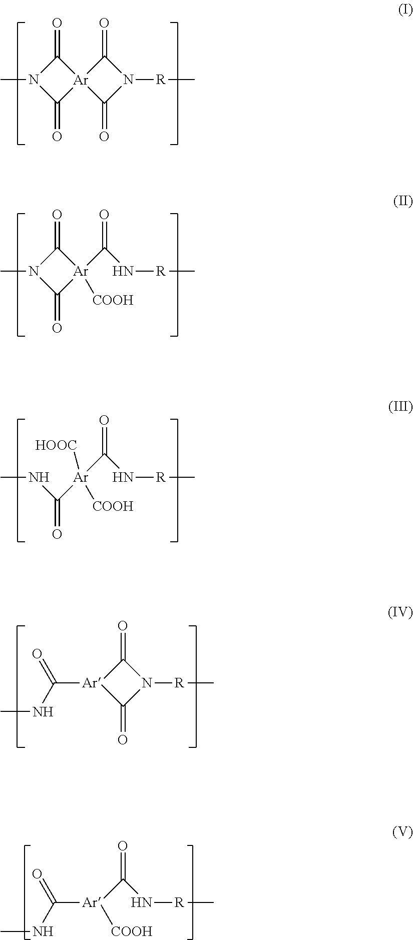

where
Ar is a tetravalent aromatic moiety and is selected from the group consisting of a substituted or unsubstituted, saturated, unsaturated or aromatic monocyclic and polycyclic group having 5 to 50 carbon atoms;
Ar′ is a trivalent aromatic moiety and is selected from the group consisting of a substituted, unsubstituted, saturated, unsaturated, aromatic monocyclic and aromatic polycyclic group having from 5 to 50 carbon atoms; and
R is selected from the group consisting of substituted and unsubstituted divalent organic radicals, for example selected from the group consisting of
   (a) aromatic hydrocarbon radicals having 6 to 20 carbon atoms and halogenated derivatives thereof;
   (b) straight or branched chain alkylene radicals having 2 to 20 carbon atoms;
   (c) cycloalkylene radicals having 3 to 20 carbon atoms, and
   (d) divalent radicals of formula (VI):

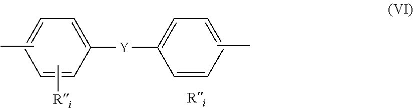

where
Y is selected from the group consisting of alkylenes of 1 to 6 carbon atoms, for example —C(CH₃)₂ and —CₙH₂ₙ— (n being an integer from 1 to 6); perfluoroalkylenes of 1 to 6 carbon atoms, for example —C(CF₃)₂ and —CₙF₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, and
R″ is selected from the group consisting of hydrogen, halogen, alkyl, alkenyl, alkynyl, aryl, ether, thioether, carboxylic acid, ester, amide, imide, alkali earth metal sulfonate, alkaline earth metal sulfonate, alkyl sulfonate, alkali earth metal phosphonate, alkaline earth metal phosphonate, alkyl phosphonate, amine and quaternary ammonium and
i, for each R″, is independently zero or an integer ranging from 1 to 4,
   with the provisio that at least one of Ar, Ar′ and R comprise at least one ether group and that the ether group is present in the polymer chain backbone.

According to an embodiment, Ar is selected from the group consisting of formulas:

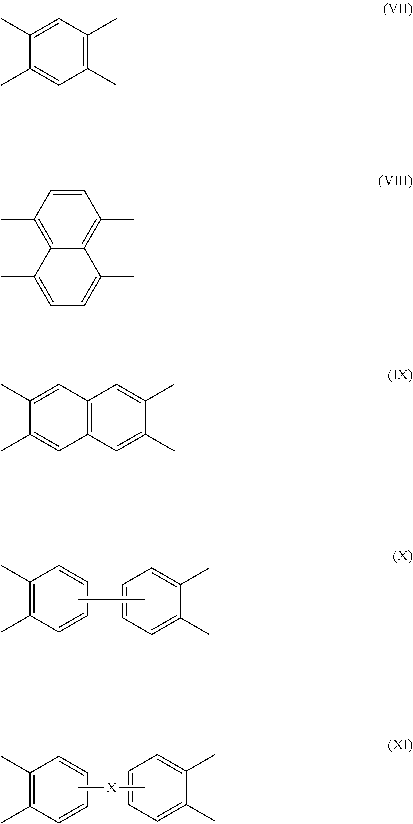

where
X is a divalent moiety, having divalent bonds in the 3,3′, 3,4′, 4,3″ or the 4,4′ positions and is selected from the group consisting of alkylenes of 1 to 6 carbon atoms, for example —C(CH₃)₂ and —CₙH₂ₙ— (n being an integer from 1 to 6); perfluoroalkylenes of 1 to 6 carbon atoms, for example —C(CF₃)₂ and —CₙF₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—;
or X is a group of the formula —O—Ar″—O—, wherein Ar″ is a aromatic moiety selected from the group consisting of a substituted or unsubstituted, saturated, unsaturated or aromatic monocyclic and polycyclic group having 5 to 50 carbon atoms.

According to an embodiment, Ar′ is selected from the group consisting of formulas:

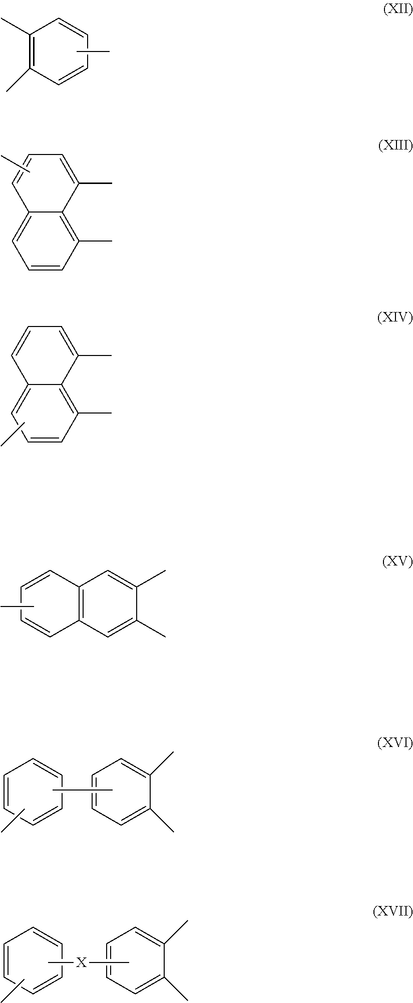

where
X is a divalent moiety, having divalent bonds in the 3,3′, 3,4′, 4,3″ or the 4,4′ positions and is selected from the group consisting of alkylenes of 1 to 6 carbon atoms, for example —C(CH₃)₂ and —CₙH₂ₙ— (n being an integer from 1 to 6); perfluoroalkylenes of 1 to 6 carbon atoms, for example —C(CF₃)₂ and —CₙF₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—;
or X is a group of the formula —O—Ar″—O—, wherein Ar″ is a aromatic moiety selected from the group consisting of a substituted or unsubstituted, saturated, unsaturated or aromatic monocyclic and polycyclic group having 5 to 50 carbon atoms.

According to an embodiment of the present disclosure, at least 50 mol. %, at least 60 mol. %, at least 70 mol. %, at least 80 mol. %, at least 90 mol. %, at least 95 mol. %, at least 99 mol. % or all of the recurring units in P1 and/or P2 are recurring units (R_{PEI}) of formulas (I), (II), (III), (IV), (V) and/or mixtures thereof, as defined above.

According to an embodiment, P1 and/or P2 comprises at least 50 mol. %, based on the total number of moles in the polymer, of recurring units (R_{PEI}) of formula (VII):

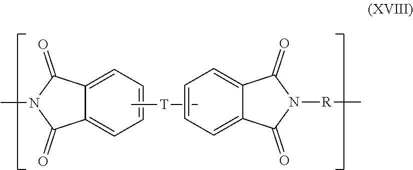

where
R is selected from the group consisting of substituted and unsubstituted divalent organic radicals, for example selected from the group consisting of
   (a) aromatic hydrocarbon radicals having 6 to 20 carbon atoms and halogenated derivatives thereof;
   (b) straight or branched chain alkylene radicals having 2 to 20 carbon atoms;
   (c) cycloalkylene radicals having 3 to 20 carbon atoms, and
   (d) divalent radicals of formula (VI):

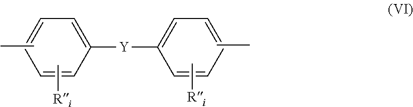

where
Y is selected from the group consisting of alkylenes of 1 to 6 carbon atoms, for example —C(CH₃)₂ and —CₙH₂ₙ— (n being an integer from 1 to 6); perfluoroalkylenes of 1 to 6 carbon atoms, for example —C(CF₃)₂ and —CₙF₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, and
R″ is selected from the group consisting of hydrogen, halogen, alkyl, alkenyl, alkynyl, aryl, ether, thioether, carboxylic acid, ester, amide, imide, alkali earth metal sulfonate, alkaline earth metal sulfonate, alkyl sulfonate, alkali earth metal phosphonate, alkaline earth metal phosphonate, alkyl phosphonate, amine and quaternary ammonium and
i, for each R″, is independently zero or an integer ranging from 1 to 4, with the provisio that at least one of Ar, Ar′ and R comprise at least one ether group and that the ether group is present in the polymer chain backbone.
T can either be
—O— or —O—Ar″—O—
   wherein the divalent bonds of the —O— or the —O—Ar″—O— group are in the 3,3′, 3,4′, 4,3′, or the 4,4′ positions,
   wherein Ar″ is a aromatic moiety selected from the group consisting of a substituted or unsubstituted, saturated, unsaturated or aromatic monocyclic and polycyclic group having 5 to 50 carbon atoms, for example a substituted or unsubstituted phenylene, a substituted or unsubstituted biphenyl group, a substituted or unsubstituted naphthalene group or a moiety comprising two substituted or unsubstituted phenylene groups.

According to an embodiment of the present disclosure, Ar″ is of the general formula (VI), as detailed above; for example, Ar″ is of formula (XIX):

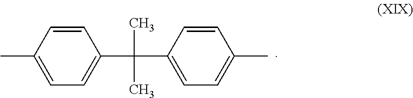

The polyetherimides (PEI) of the present invention may be prepared by any of the methods well-known to those skilled in the art including the reaction of a diamino compound of the formula H₂N—R—NH₂ (XX), where R is as defined before, with any aromatic bis(ether anhydride)s of the formula (XXI):

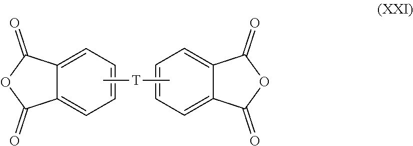

where T as defined before.

In general, the preparation can be carried out in solvents, e.g. o-dichlorobenzene, m-cresol/toluene, N,N-dimethylacetamide, at temperatures ranging from 20° C. to 250° C.

Alternatively, these polyetherimides can be prepared by melt polymerization of any dianhydrides of formula (XXI) with any diamino compound of formula (XX) while heating the mixture of the ingredients at elevated temperatures with concurrent intermixing.

The aromatic bis(ether anhydride)s of formula (XXI) include, for example:
2,2-bis[4-(2,3-dicarboxyphenoxy)phenyl]propane dianhydride;
4,4′-bis(2,3-dicarboxyphenoxy)diphenyl ether dianhydride;
1,3-bis(2,3-dicarboxyphenoxy)benzene dianhydride;
4,4′-bis(2,3-dicarboxyphenoxy)diphenyl sulfide dianhydride;
1,4-bis(2,3-dicarboxyphenoxy)benzene dianhydride;
4,4′-bis(2,3-dicarboxyphenoxy)benzophenone dianhydride;
4,4′-bis(2,3-dicarboxyphenoxy)diphenyl sulfone dianhydride;
2,2-bis[4 (3,4-dicarboxyphenoxy)phenyl]propane dianhydride;
4,4′-bis(3,4-dicarboxyphenoxy)diphenyl ether dianhydride;
4,4′-bis(3,4-dicarboxyphenoxy)diphenyl sulfide dianhydride;
1,3-bis(3,4-dicarboxyphenoxy)benzene dianhydride;
1,4-bis(3,4-dicarboxyphenoxy)benzene dianhydride;
4,4′-bis(3,4-dicarboxyphenoxy)benzophenone dianhydride;
4-(2,3-dicarboxyphenoxy)-4′-(3,4-dicarboxyphenoxy)diphenyl-2,2-propane dianhydride; and mixtures of such dianhydrides.

The organic diamines of formula (XX) are chosen from the group consisting of m-phenylenediamine, p-phenylenediamine, 2,2-bis(p-aminophenyl)propane, 4,4′-diaminodiphenyl-methane, 4,4′-diaminodiphenyl sulfide, 4,4′-diamino diphenyl sulfone, 4,4′-diaminodiphenyl ether, 1,5-diaminonaphthalene, 3,3′-dimethylbenzidine, 3,3′-dimethoxybenzidine, and mixtures thereof; preferably, the organic diamines of formula (XX) are chosen from the group consisting of m-phenylenediamine and p-phenylenediamine and mixture thereof.

According to an embodiment, P1 and/or P2 comprises at least 50 mol. %, based on the total number of moles in the polymer, of recurring units (R_{PEI}) of formulas (XXIII) or (XXIV), in imide forms, or their corresponding amic acid forms and mixtures thereof:

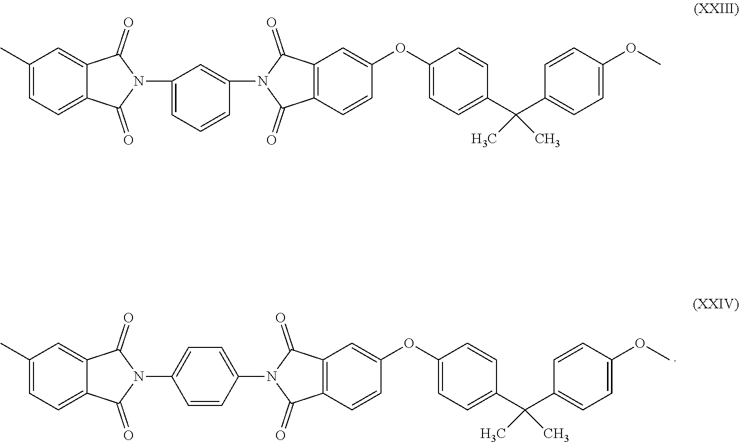

In a preferred embodiment of the present invention, at least 50 mol. %, at least 60 mol. %, at least 70 mol. %, at least 80 mol. %, at least 90 mol. %, at least 95 mol. %, at least 99 mol. % or all of the recurring units in P1 and/or P2 are recurring units (R_{PEI}) of formulas (XXIII) or (XXIV), in imide forms, or their corresponding amic acid forms and mixtures thereof.

Aromatic polyimides are commercially available from Sabic Innovative Plastics as ULTEM® polyetherimides.

In a specific embodiment, P1 and/or P2 has a Tg ranging from 160 and 270° C., as measured by differential scanning calorimetry (DSC) according to ASTM D3418, for example ranging from 170 and 260° C., from 180 and 250° C.

### Polycarbonate (PC)

According to an embodiment of the present invention, P1 and/or P2 are polycarbonate (PC) polymers as below defined. In other words, according to this embodiment, P1 and/or P2 comprise PC recurring units (R_{PC}).

According to an embodiment of the present invention, P1 and/or P2 comprises at least 50 wt. % of the recurring units (R_{PC}) comprising at least one optionally substituted arylene group and at least one carbonate group (—O—C(═O)—O).

The arylene group contained in the recurring units (R_{PC}) is preferably selected from phenylenes and naphthylenes and can be substituted or unsubstituted.

The recurring units (R_{PC}) can be obtained by the polycondensation reaction of a carbonic acid derivative, typically diphenyl carbonate Ph—O—C(═O)—O—Ph, wherein Ph is phenyl, or phosgene Cl—C(═O)—Cl, and at least one optionally substituted aromatic diol (D) HO—R—OH in which R is a C6-C50 divalent radical comprising at least one arylene group.

The optionally substituted arylene group of the aromatic diol (D) is preferably selected from optionally substituted phenylenes and optionally substituted naphthylenes.

The aromatic diol (D) is preferably selected from aromatic diols complying with formulae (D-A) and (D-B) here below:

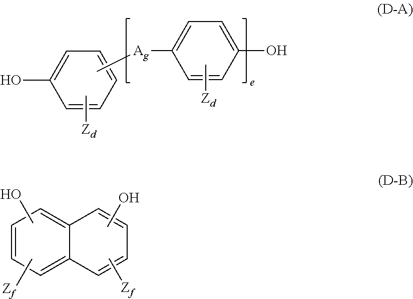

A is selected from the group consisting of C1-C8 alkylenes, C2-C8 alkylidenes, C5-C15 cycloalkylenes, C5-C15 cycloalkylidenes, carbonyl atom, oxygen atom, sulfur atom, SO and SO₂,
Z is selected from F, Cl, Br, I, C1-C4 alkyls; if several Z radicals are substituents, they may be identical or different from one another;
e denotes an integer from 0 to 1;
g denotes an integer from 0 to 1;
d denotes an integer from 0 to 4; and
f denotes an integer from 0 to 3.

Preferably, aromatic diols (D) are selected in the group consisting of 2,2 bis-(4-hydroxyphenyl)-propane (bisphenol A), 2,2 bis (3,5 dimethyl 4 hydroxyphenyl) propane, 2,2,4-trimethyl cyclohexyl 1,1-diphenol and 1,1-bis-(4-hydroxy-phenyl)-cyclohexane.

Among the aromatic polycarbonates suitable in the practice of the invention as aromatic polycarbonates (PC) are included phenolphthalein-based polycarbonates, copolycarbonates and terpolycarbonates.

According to an embodiment of the present invention, more than 60 wt. %, more than 70 wt. %, more than 80 wt. %, more than 90 wt. %, more than 95 wt. %, more than 98 wt. %, or 100 wt. % of the recurring units of P1 and/or P2 are recurring units (R_{PC}).

According to another embodiment, the recurring units of P1 and/or P2 consist essentially of recurring units (R_{PC}) obtained by the polycondensation reaction of a carbonic acid derivative with bisphenol A.

### Optional Components in the Blends

The blends of the present invention may comprise one or more solvents.

The solvents can notably be polar solvents selected form the group consisting of N-methyl-pyrrolidone (NMP), dichloromethane, dimethyl formamide (DMF), dimethyl acetamide (DMAc) diphenylsulfone, sulfolane, dimethyl sulfoxide (DMSO) and chlorobenzene.

The blends of the present invention may comprise one or more additives.

The additives can notably be selected from the group consisting of filler (e.g. glass fibers, carbon fibers), lubricants, plasticizers, fire retardants, rheology modifiers, stabilizers and pigments.

The blends of the present invention may comprise one or more thermal adduct formers.

The thermal adduct formers can notably be selected from the group consisting of fullerenes (C₆₀, C₇₀, fullerite), bismaleimide (4,4′-bismaleimido-diphenylmethane), phenylene dimaleimides (e.g. N,N′-(1,2-phenylene)dimaleimide, N,N′-(1,3-phenylene)dimaleimide, N,N′-(1,4-phenylene)dimaleimide).

The thermal adduct formers can for example be a difunctional maleimide, for example according to formula:

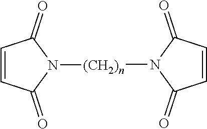

where n is an integer chosen from 1 to 18.

The thermal adduct formers can for example be a trifunctional maleimide, for example according to formulas:

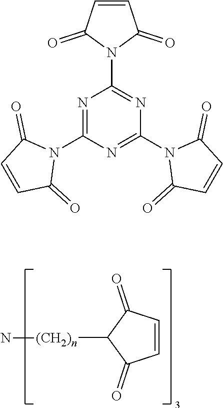

where n is an integer chosen from 1 to 18. The blends of the present invention may comprise one or more UV adduct formers.

The UV adduct formers can for example be according to formulas:

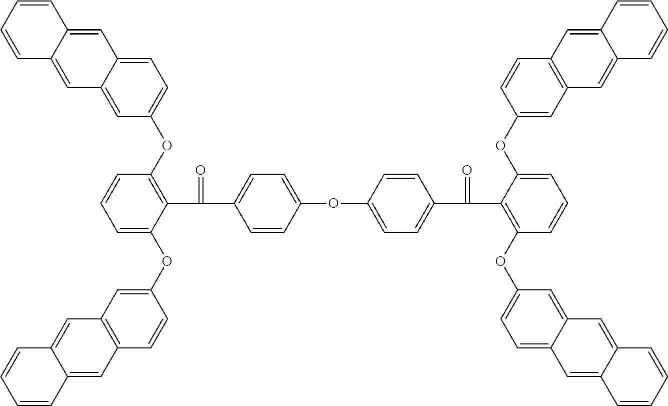 [SMILES: O=C(c1ccc(Oc2ccc(C(=O)c3c(Oc4ccc5cc6ccccc6cc5c4)cccc3Oc3ccc4cc5ccccc5cc4c3)cc2)cc1)c1c(Oc2ccc3cc4ccccc4cc3c2)cccc1Oc1ccc2cc3ccccc3cc2c1]

### Polymer Adducts

The present invention also relates to polymer adducts. A cycloaddition reaction is a reaction in which two or more unsaturated molecules (or parts of the same molecule) combine with the formation of a cyclic adduct in which there is a net reduction of the bond multiplicity, as defined in International Union of Pure and Applied Chemistry, Compendium of Chemical Terminology, Gold Book, Version 2.3.3 Feb. 24, 2014, page 367).

The polymer adducts of the present invention are obtained by exposing to UV light at a wavelength ranging from 300 nm to 600 nm, preferably from 350 nm to 400 nm:
a polymer (P1) comprising recurring units (R_{P1}) selected from the group consisting of poly(aryl ether sulfone) (PAES), poly(aryl ether ketone) (PAEK), poly(amide imide) (PAD, polyphenylene (PP), poly(ether imide) (PEI) and polycarbonate (PC), and comprising at least one moiety (M1):

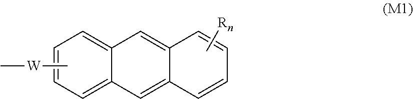

wherein:
W is a bond, O, C(O), S, SO₂, C(O)NH, C(O)O, O—C(O)—O, NH—C(O)NH—, NH—C(O)—O, an imine-containing moiety or an imide-containing moiety; R is a halogen atom or an alkyl group, optionally branched, preferably an C1-C18 alkyl group optionally substituted with one or several halogen atoms; and
n is 0 or an integer from 1 to 9, preferably 0; or
the blend of the present invention.

The present invention also relates to polymer adduct obtained by heating at a temperature ranging from 60° C. to 250° C., preferably from 65° C. to 200° C., the blend of the present invention.

### Polymer (P1)

The present invention also relates to a polymer (P1) comprising:
recurring units (R_{PPSU}) of formula (L-A):

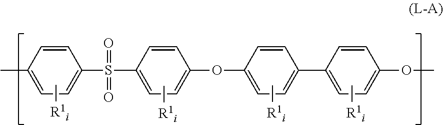

at least one moiety (M1):

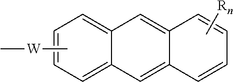

wherein:
each R¹ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is an integer independently selected from 0 to 4;
W is O, C(O), S, SO₂, C(O)NH, C(O)O, O—C(O)—O, NH—C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; and

According to an embodiment, P1 comprises at least one terminal group of formula (M-A):

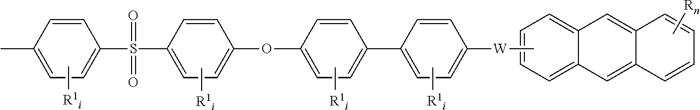

wherein R1, I, W, R and n are as above defined.

According to an embodiment, P1 is such that in formula (M1) or (M-A), n is 0 and W is O.

According to an embodiment, P1 is such that in formula (M1) or (M-A), W is at the 2-position of the anthracene ring.

According to an embodiment, P1 has a number average molecular weight (Mn) of less than about 25,000 g/mol, less than about 15,000 g/mol, or less than about 10,000 g/mol, as measured by gel permeation chromatography (GPC) using methylene chloride as a mobile phase, with polystyrene standards.

### Applications

The present invention also relates to a method for coating a surface, comprising:
a) applying to the surface:
   a polymer (P1) comprising recurring units (R_{P1}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moeity (M1):

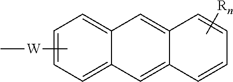

wherein:
W is a bond, O, C(O), S, SO₂, C(O)NH, C(O)O, O—C(O)—O, NH—C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; and
the blend of the present invention,
   optionally in combination with one or more solvents and/or additives,
   b) irradiating the surface at a wavelength ranging from 300 nm to 600 nm, preferably from 350 nm to 400 nm, or
   b′) heating the surface at a temperature ranging from 60° C. to 250° C., preferably from 65° C. to 200° C.

The present invention also relates to a method for manufacturing a formed article, comprising:

a) applying to a mould:
a polymer (P1) comprising recurring units (R_{P1}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moiety (M1):

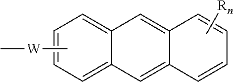

wherein:
W is a bond, O, C(O), S, SO₂, C(O)NH, C(O)O, O—C(O)—O, NH—C(O)NH—, NH—C(O)—O, an imine-containing moiety or an imide-containing moiety; R is a halogen atom or an alkyl group, optionally branched, preferably an C1-C18 alkyl group optionally substituted with one or several halogen atoms; and
n is 0 or an integer from 1 to 9, preferably 0; and
the blend of the present invention,
   optionally in combination with one or more solvents and/or additives,
   b) irradiating the mould at a wavelength ranging from 300 nm to 600 nm, preferably from 350 nm to 400 nm, or
   b′) heating the mould at a temperature ranging from 60° C. to 250° C., preferably from 65° C. to 200° C.

The present invention also relates to a method recycling a coating or a formed article, comprising the polymer adduct obtained by exposing a polymer (P1) to UV light at a wavelength ranging from 300 nm to 600 nm, wherein polymer (P1) comprises recurring units (R_{P1}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moiety (M1):

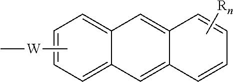

wherein:
   W is a bond, O, C(O), S, SO₂, C(O)NH, C(O)O, O—C(O)—O, NH—C(O)NH—, NH—C(O)—O, an imine-containing moiety or an imide-containing moiety;
   R is a halogen atom or an alkyl group, optionally branched, preferably an C1-C18 alkyl group optionally substituted with one or several halogen atoms; and
   n is 0 or an integer from 1 to 9, preferably 0; or
wherein the method comprises submitting the coating or formed article to UV irradiation at a wavelengths lower than 300 nm.

The present invention also relates to a method for recycling a coating or a formed article, comprising the polymer adduct of the present invention, by submitting the coating or formed article to heating at a temperature ranging from 100° C. to 500° C., preferably from 200° C. to 400° C., more preferably from 250° C. to 350° C.

The present invention also relates to a recycled material obtainable by the recycling methods above-defined.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### EXAMPLES

### Materials and Methods

In the examples below, molecular weight was determined using GPC analysis with methylene chloride as the eluent and referenced to polystyrene standards of known molecular weight. GPC analysis was performed with a Waters 2695 separations module with a Waters 2487 Dual Wavelength UV detector (Milford, Mass., USA).

Differential scanning calorimetry (DSC) was performed to determine glass transition temperature (“Tg”). Thermogravimetric analysis (TGA) was used to determine onset degradation temperature, Td5. Td5 is the temperature at which the polymer sample lost 5% of its mass.

Glass transition temperatures were determined by DSC using a TA Instruments DSC Q20 differential scanning calorimeter (New Castle, Del., USA) with a temperature ramp rate of 20° C./min. Td5 was determined by TGA using a TA Instruments TGA Q500 thermogravimetric analyzer with a temperature ramp rate of about 10° C./min.

### Example 1—Synthesis of a Polymer (P1) Having Anthracene End-Groups (AnPSU)

A polysulfone polymer with anthracene end-groups was synthesised according to the following reaction scheme:

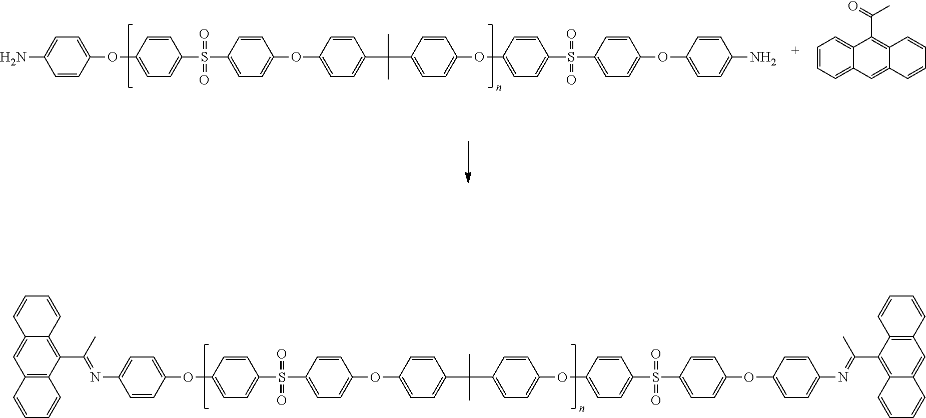

Five grams of amine-terminated polysulfone (PSU) oligomer (Virantage® VW-30500 RP, Solvay Specialty Polymers), 0.875 g of 9-acetylanthracene (Sigma-Aldrich), and 15 mL of monochlorobenzene (MCB, Acros) were added to a 100 mL 3-neck round bottomed flask equipped with a nitrogen inlet, outlet, mechanical stirrer, Dean-Stark trap, and water-cooled condenser. The flask was heated until the solids dissolved, at which point 0.038 g of p-toluenesulfonic acid (Alfa-Aesar) was added and rinsed into the flask with an additional 15 mL MCB. The mixture was stirred and heated to reflux (131° C.), and allowed to reflux for 17 hours. The mixture was cooled to room temperature, diluted with 15 mL MCB, and poured into 400 mL of methanol to coagulate the polymer, which was collected by vacuum filtration. Twice more the polymer was dissolved in 45 mL of MCB, coagulated by pouring into 400 mL of methanol, and collected by vacuum filtration. The polymer was dried by heating in a vacuum oven at 100° C. for two hours to yield 4.27 g (AnPSU). Remaining amine end-groups were determined by titrating a solution of the sample in dichloromethane with a solution of 0.1 N perchloric acid in acetic acid. Titration of the starting PSU polymer indicated that it contained 327 μeq/g of amine end groups, while titration of the anthracene terminated polymer showed that it contained only 254 μeq/g of amine end groups, with the difference attributed to conversion of 22% of the amine end groups to anthracene end groups.

### Example 2—UV Chain Extension (366 nm) and Reversal (254 nm) of the Polymer (P1) of Example 1

The polymer of Example 1 (0.20 g) was dissolved in 15 mL of methylene chloride (Fisher). The stirred solution was illuminated for six hours with a hand held UV lamp (VWR UV-AC Dual Hand Lamp 89131-492) set to a wavelength of 366 nm and held at a distance of 2.5 cm from the surface of the stirred solution, causing the solution to emit a blue glow. During the 6 hour period some methylene chloride evaporated, so additional methylene chloride was added as necessary to maintain a constant volume. After 6 hours, the remaining methylene chloride was allowed to completely evaporate, and the polymer was dried at 100° C. under vacuum for 16 hours (ExPSU).

By similar means, ExPSU was illuminated with 254 nm light for 6 hours (RePSU), and as a control, the polymer of Example 1 was illuminated with 254 nm for 6 hours (UVPSU). Gel permeation chromatography (GPC) was used to compare the molecular weight distributions of the samples; the results are reported in Table 1 here below.

TABLE 1
GPC data for the polymer of Example 1 and derivatives

| | | Mₙ | M_{w} | M_{z} | M_{z+1} | |
|---|---|---|---|---|---|---|
| Sample | Description | (kDa) | (kDa) | (kDa) | (kDa) | M_{w}/Mₙ |
| PSU | Original PSU polymer | 6.9 | 15.4 | 26.1 | 39.5 | 2.22 |
| AnPSU | Anthracene end capped | 7.5 | 15.2 | 24.8 | 35.8 | 2.04 |
| | PSU | | | | | |
| ExPSU | Chain extended PSU | 8.9 | 40.4 | 273.9 | 587.6 | 4.52 |
| RePSU | Reversed chain extension | 4.7 | 10.7 | 19.6 | 30.7 | 2.28 |
| UVPSU | 254 nm Control | 5.6 | 13.1 | 23.3 | 35.2 | 2.35 |

The results show that the initial anthracene end capping had little effect on the molecular weight distribution. After illumination with 366 nm light, the molecular weights increased, more so for the higher order molecular weights. The molecular weight increase was reversed by illumination with 254 nm light, while a control sample of the original PSU polymer was only slightly affected by the 254 nm light.

This example thus demonstrates the reversible formation of a polymer adduct.

### Example 3—Synthesis of a Polymer (P1) Having Anthracene End-Groups (AnPPSU)

A polyphenylsulfone polymer having anthracene end-groups was synthesized according to the following reaction scheme:

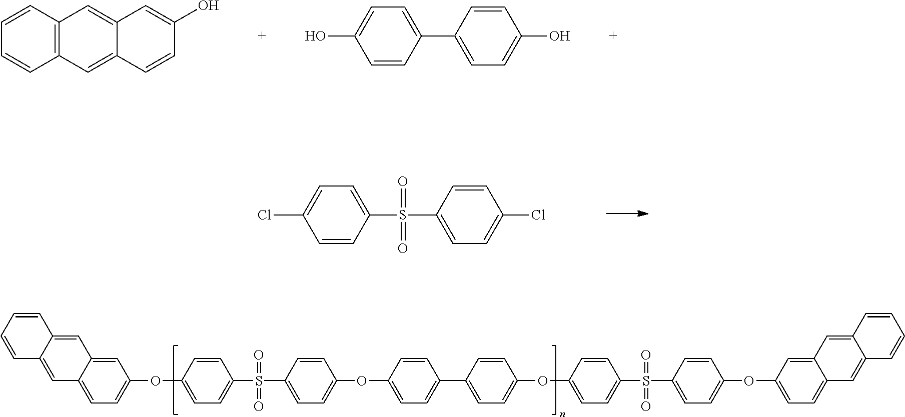

following the procedure illustrated herein.

In a 250 mL 3-neck round bottomed flask, 7.29 g of 4,4′-dichlorodiphenylsulfone (Solvay Specialty Polymers), 4.46 g 4,4′-biphenol (TCl), 3.89 g K₂CO₃ (Armand Products), 0.548 g 2-anthracenol (BOC Sciences), and 28.69 g sulfolane (Chevron Phillips) were combined. The flask was fitted with a Dean-Stark trap, a water chilled condenser above the trap, a mechanical stirrer, a gas inlet and outlet, and a thermocouple. The flask was purged with argon and heated to maintain the contents at 210° C. for 3 hours while stirring at 150 rpm. The solution was then cooled to 150° C. and diluted with 50 mL of NMP (Fisher). The solution was then pressure filtered through a glass fiber filter disc (Whatman GC/D). The polymer was coagulated by pouring the NMP/sulfolane solution into 500 mL of methanol (VWR) while agitating with a laboratory blender. A pale pink precipitate was collected by filtration, washed three times with 500 mL portions of boiling DI water, and three times with 500 mL portions of methanol. The powder was then dried at 110° C. in a vacuum oven for 16 hours to yield 8.76 g of anthracene terminated (AnPPSU).

### Example 4—UV Chain Extension (366 nm) and Reversal (254 nm) of the Polymer of Example 3 in Solution

In an evaporating dish, 3.03 g of anthracene terminated PPSU (AnPPSU) of Example 3 was dissolved in 40 mL of methylene chloride and illuminated with 366 nm light at a distance of 4 cm, while stirring. The solution produced a pleasing blue fluorescent glow when under the UV lamp. Due to solvent evaporation, every 20-30 minutes 15-20 mL of methylene chloride was added to maintain a volume of about 40 mL. After 4 hours the methylene chloride was removed under reduced pressure using a rotary evaporator, and the solid residue was dried in a vacuum oven at 100° C. for 15 hours to obtain an amber solid (ExPPSU).

By a similar means, ExPPSU was dissolved and illuminated with 254 nm light for 5 hours and dried to recover a brown solid (RePPSU). As a control, a chlorine terminated PPSU polymer was prepared as described in Example 3, leaving out the 2-anthracenol, and the sample was irradiated with 254 nm or 366 nm light for 5 hours and dried to recover a brown solid (UVPPSU). In a separate procedure, a sample of ExPPSU was placed between two pieces of glass and heated to 240° C., then cooled to room temperature, to collect a brown solid (ThPPSU). GPC was used to compare the molecular weight distributions of the samples; the results are reported in Table 1 here below.

TABLE 2
GPC data for PPSU polymer of Example 3 and derivatives.

| | | Mₙ | M_{w} | M_{z} | M_{z+1} | |
|---|---|---|---|---|---|---|
| Sample | Description | (kDa) | (kDa) | (kDa) | (kDa) | M_{w}/Mₙ |
| AnPPSU | Anthracene end | 10.0 | 24.0 | 40.4 | 57.5 | 2.41 |
| | capped PPSU | | | | | |
| ExPPSU | Chain extended | 16.1 | 46.2 | 87.9 | 136.9 | 2.87 |
| | PPSU | | | | | |
| RePPSU | UV-reversed chain | 13.7 | 42.3 | 82.8 | 127.7 | 3.08 |
| | extension (254 nm) | | | | | |
| ThPPSU | Thermally reversed | 12.8 | 33.7 | 61.4 | 93.2 | 2.64 |
| | chain extension | | | | | |
| | (240° C.) | | | | | |
| AbPPSU | AnPPSU exposed to | 11.9 | 29.7 | 52.5 | 78.6 | 2.50 |
| | 254 nm | | | | | |
| PPSU | CI-terminated PPSU | 10.5 | 22.0 | 33.6 | 44.9 | 2.11 |
| UVPPSU254 | 254 nm control | 10.7 | 21.6 | 32.7 | 44.0 | 2.02 |
| UVPPSU366 | 366 nm control | 9.8 | 21.6 | 34.4 | 47.8 | 2.19 |

The result show that, after illumination of AnPPSU with 366 nm light, the molecular weight increased, with M_{w} almost doubling in the resulting adduct (ExPPSU). A Cl-terminated PPSU control exposed to 366 nm light was almost unaffected (UVPPSU366). Exposure of ExPPSU to 254 nm light reduced the molecular weight (RePPSU), but did not reduce it to its original value. Treatment of the AnPPSU with 254 nm light resulted in a slight increase in the molecular weight distribution (AbPPSU). The Cl-terminated PPSU control sample was also unaffected by exposure to 254 nm light (UVPPSU254). Heating a sample of ExPPSU to 240° C. was more effective at reversing the chain extension (ThPPSU). The molecular weight distributions for the various anthracene terminated PPSU samples were monomodal, and the entire GPC curve shifted after chain extension or reversal.

TGA analysis showed that anthracene-terminated PPSU (AnPPSU) has good thermal stability, both before and after chain extension, and exhibits glass transition temperatures similar to conventional PPSU.

TGA analysis showed that AnPPSU is quite thermally stable, not experiencing 5% weight loss until 510° C. After chain extension, ExPPSU loses 1 wt % of volatile material at about 217° C., and loses 5% of the remaining mass at 502° C. The initial Tg of AnPPSU is 210° C., which increases after chain extension to 215° C. in ExPPSU. Degradation temperatures and glass transition temperatures are reported in Table 3 here below.

TABLE 3
Degradation onset temperatures (T_{d5}) and glass
transition temperatures (T_{g}) for AnPPSU and ExPPSU.

| Sample | T_{d5} (° C.) | T_{g} (° C.) |
|---|---|---|
| AnPPSU | 510 | 210 |
| ExPPSU | 502 | 215 |

### Example 5—UV Chain Extension (366 nm) of the Polymer of Example 3 in the Melt Phase

Chain extension of the anthracene terminated PPSU (AnPPSU) of Example 3 was demonstrated in the melt phase. A 60 mg sample of AnPPSU was placed between two borosilicate glass plates on top of a hot plate. A thin-wire thermocouple was also placed between the glass plates in contact with the sample, the sample was heated to 235° C., and irradiated at 366 nm for varying lengths of time. The molecular weight was observed to increase as the UV exposure time was increased. The results are reported in Table 4 below.

TABLE 4
GPC data for the AnPPSU of Example 3 as a function of time
during exposure to UV light at 366 nm while heated to 235° C.

| | Time (m) | | | |
|---|---|---|---|---|
| | 0 | 5 | 60 | 210 |
| Mₙ (kDa) | 11.2 | 11.7 | 12.5 | 13.1 |
| M_{w} (kDa) | 26.9 | 27.8 | 31.9 | 39.2 |
| M_{z} (kDa) | 44.1 | 45.8 | 63.4 | 119.5 |
| M_{z+1} (kDa) | 61.8 | 64.4 | 127.4 | 352.5 |
| M_{w}/Mₙ | 2.4 | 2.4 | 2.6 | 3.0 |
| M_{z}/M_{w} | 1.6 | 1.7 | 2.0 | 3.1 |

### Example 6—Synthesis of a Polymer (P2) Having Maleimide End-Groups (MaPSU)

A polysulfone polymer having maleimide end groups was synthesized according to the following reaction scheme:

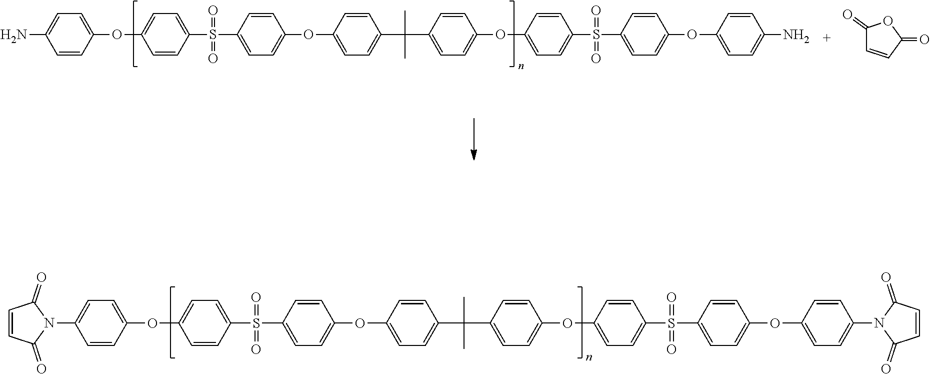

following the procedure illustrated herein.

Amine-terminated polysulfone (PSU) oligomer (Virantage® VW-30500 RP, Solvay Specialty Polymers) (10 g, 0.0021 mol, 1.0 eq.) and maleic anhydride (1.21 g, 0.0123 mol, 3.0 eq. based on end groups) were added to a 200 mL 3-neck flask equipped with a mechanical stirrer, Dean-Stark trap, and nitrogen sparge tube. The resulting mixture was then dissolved in 75 mL of dry DMAc and 20 mL of chlorobenzene and allowed to stir for 7 h at 25° C. under nitrogen to produce the amic acid. Subsequently the temperature was increased to 130° C. for 17 h to cyclodehydrate the amic acid and produce the maleimide terminated PSU (MaPSU). The cyclodehydration process resulted in the collection of 25 mL of clear colorless liquid in the dean stark trap. Presumably this mixture was comprised of MCB, DMAc, and water. The reaction was then cooled to room temperature and the remaining dark brown solution was coagulated in a Waring blender containing ˜500 mL of (50:50, Water:MeOH). A fine tan/brown powder was then collected via vacuum filtration into a Buchner funnel. The coagulation solids were then washed with hot water (3×500 mL) and methanol (6×500 mL) to give a light tan/brown powder that was further washed via Soxhlet extraction with recycling MeOH and dried in a vacuum oven to yield 7.2 g (72%) of maleimide terminated PSU. End group conversion was determined by titrating a solution of the sample in dichloromethane with a solution of 0.1 N perchloric acid in acetic acid. Titration of the starting PSU polymer indicated that it contained 410 μeq/g of amine end groups, while titration of the maleimide terminated oligomer showed that it contained only 6.9 μeq/g of amine end groups, with the difference attributed to conversion of 98% of the amine end groups to maleimide end groups.

### Example 7—Blends and Chain Extension by Heating of the Polymers of Examples 3 and 6 and Chain Extension by Heating

Using a 3-neck round bottom flask (100 mL) equipped with a mechanical stirrer and blanketed under nitrogen, 0.404 g of the maleimide terminated PSU of Example 6 (MaPSU), possessing 403.7 μeq/g of reactive chain ends and 0.650 g of anthracene terminated PPSU (AnPPSU) similar to Example 3 (same chemical structure, but obtained through a new run, having a different Mn), possessing 250.71 μeq/g of reactive chain ends, were dissolved in 2.5 g of sulfolane to establish a reaction mixture possessing a stoichiometry of 1:1 with respect to reactive chain ends. Using an oil bath, the 1:1 blend was then heated to 200° C. for 2 min, which reduced the viscosity to allow for full dissolution, and was then quickly cooled to 170° C. and held isothermally for 22 h at which point the mixture was cooled quickly in a water bath to room temperature, diluted with NMP (20 mL), coagulated into a 1:1 mixture of MeOH:H2O (˜500 mL), and the solids were collected via vacuum filtration. The resulting powder was then repeatedly washed with boiling water (3×500 mL) and methanol (3×500 mL) to give a dark tan powder.

GPC was used to compare the molecular weight distributions of the samples; the results are reported in Table 5 here below.

TABLE 5
GPC Data Showing Changes in Molecular Weight
For Maleimide-Anthracene Blends

| Sample | | | | | Blend 1:1 |
|---|---|---|---|---|---|
| Name | | MaPSU | AnPPSU | Blend 1:1 | after heating |
| Mₙ | g/mol | 6,009 | 11,056 | 8,778 | 14,105 |
| M_{w} | g/mol | 12,355 | 26,358 | 24,274 | 37,263 |
| M_{w}/Mₙ | g/mol | 2.77 | 2.38 | 2.77 | 2.64 |
| M_{z} | g/mol | 19,700 | 43,629 | 44,526 | 67,067 |
| M_{z} + 1 | g/mol | 27,107 | 61,577 | 66,055 | 103,878 |
| M_{z}/M_{w} | g/mol | 1.59 | 1.66 | 1.83 | 1.80 |

After heating the binary mixture, the molecular weight increased, with M_{w} increasing from 24,274 g/mol to 37,263 g/mol giving evidence of chain extension by Diels-Alder adduct formation.

### Example 8—Thermal Chain Extension of Polymer of Example 3 with 4,4′-Bismaleimido-diphenylmethane

A 100 mL 3-neck flask equipped with a mechanical stirrer, a thermocouple, and a gas inlet/outlet was loaded with 2.550 g of anthracene terminated PPSU (AnPPSU) similar to Example 3 (same chemical structure, but obtained through a new run, having a different Mn), 0.118 g of 4,4′-bismaleimido-diphenylmethane, and 11 g of sulfolane. The mixture was heated while stirring at 20 rpm with a temperature ramp of 2.5° C./min until reaching 100° C. The stirring was then increased to 160 rpm, and the temperature ramp was increased to 5° C./min until reaching 175° C. The reaction mixture was then held at 175° C. for 16 hours. The mixture was poured into a stirred solution of 250 mL of methanol and 250 mL of hot deionized water producing a solid precipitate. The precipitate was washed three times with 250 mL of hot deionized water and three times with 250 mL of methanol and collected by vacuum filtration. The resulting product was dried in a vacuum oven at 30 mmHg and 100° C. for 72 hours, to obtain 2.485 g of dry solid (PPSU-An-MaI-An-PPSU).

TABLE 6
GPC Data Showing Changes in Molecular Weight
For Maleimide-Anthracene Blends

| Sample | | | |
|---|---|---|---|
| Name | | AnPPSU | PPSU-An-Mal-An-PPSU |
| Mₙ | g/mol | 7,140 | 11,448 |
| M_{w} | g/mol | 17,091 | 59,871 |
| M_{w}/Mₙ | g/mol | 2.39 | 5.23 |
| M_{z} | g/mol | 30,669 | 356,873 |
| M_{z} + 1 | g/mol | 45,597 | 797,740 |
| M_{z}/M_{w} | g/mol | 1.79 | 5.96 |

1. A blend comprising at least two distinct polymers selected from the group consisting of:
at least one polymer (P1) comprising recurring units (R_{P1}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moiety (M1): 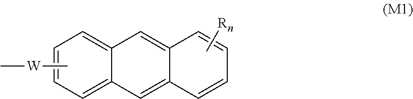
wherein:
W is a bond, O, C(O), S, SO₂, C(O)NH, C(O)O, O—C(O)—O, NH—C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; and
optionally at least one polymer (P2) comprising recurring units (R_{P2}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least moiety (M2a) or (M2b): 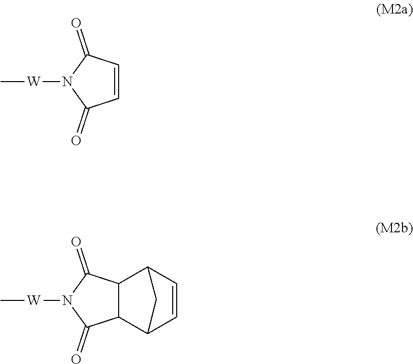
wherein:
W is a bond, O, C(O), S, SO₂, C(O)NH, C(O)O, O—C(O)—O, NH—C(O)NH—, NH—C(O)—O, an imine-containing moiety or an imide-containing moiety.

2. The blend of claim 1, wherein at least one of the one of the polymer (P1) and/or polymer (P2) is PAES and comprises recurring units (R_{P1}) of formula (L): 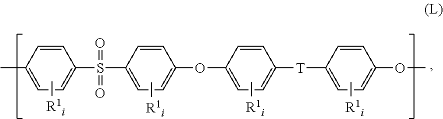
wherein:
each R¹ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is an integer independently selected from 0 to 4;
T is selected from the group consisting of a bond, —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ— with m being an integer from 1 to 6; an aliphatic divalent group, linear or branched, of up to 6 carbon atoms, and combinations thereof.

3. The blend of claim 2, wherein T is selected from the group consisting of a bond, —SO₂— and —C(CH₃)₂—.

4. The blend of any one of claims 2-3, wherein at least one of the PAES polymers (P1) and/or (P2) comprises at least 50 mol. % (based on the total number of moles in the PAES polymer) of recurring units (R_{P1}) of formula (L).

5. The blend of any one of claims 2-3, wherein at least one of the PAES polymers (P1) and/or (P2) comprises at least 50 mol. % (based on the total number of moles in the PAES polymer) of recurring units (R_{P1}) selected from the group consisting of formulas (L-A), (L-B) or (L-C):

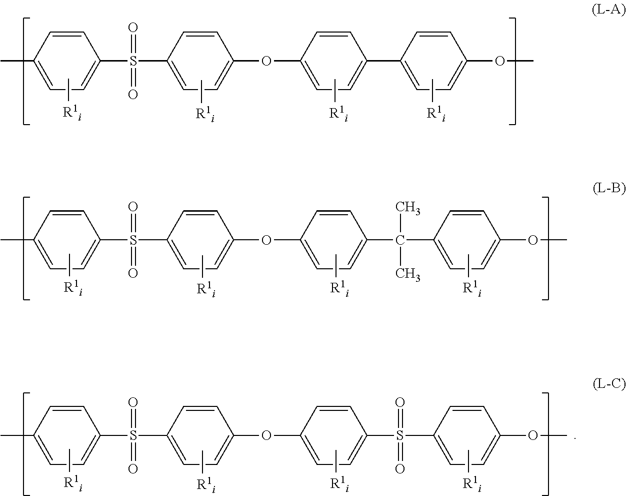

6. The blend of claim 1, comprising at least one polymer (P1) and at least one polymer (P2).

7. A polymer adduct obtained by exposing to UV light at a wavelength ranging from 300 nm to 600 nm, preferably from 350 nm to 400 nm:
a polymer (P1) comprising recurring units (R_{P1}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moiety (M1): 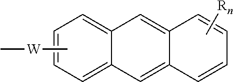
wherein:
W is a bond, O, C(O), S, SO₂, C(O)NH, C(O)O, O—C(O)—O, NH—C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; or
the blend of any one of claims 1 to 6.

8. A polymer adduct obtained by heating at a temperature ranging from 60° C. to 250° C., preferably from 65° C. to 200° C., the blend of any one of claims 1 to 6.

9. A method for coating a surface, comprising:
a) applying to the surface:
a polymer (P1) comprising recurring units (R_{P1}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moiety (M1): 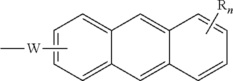
wherein:
W is a bond, O, C(O), S, SO₂, C(O)NH, C(O)O, O—C(O)—O, NH—C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; and
the blend of any one of claims 1 to 5,
optionally in combination with one or more solvents and/or additives,
b) irradiating the surface at a wavelength ranging from 300 nm to 600 nm, preferably from 350 nm to 400 nm, or
b′) heating the surface at a temperature ranging from 60° C. to 250° C., preferably from 65° C. to 200° C.

10. A method for manufacturing a formed article, comprising:
a) applying to a mould:
a polymer (P1) comprising recurring units (R_{P1}) selected from the group consisting of poly(aryl ether sulfone) (PAES), poly(aryl ether ketone) (PAEK), poly(amide imide) (PAI), polyphenylene (PP), poly(ether imide) (PEI) and polycarbonate (PC), and comprising at least one moeity (M1): 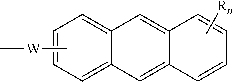
wherein:
W is a bond, O, C(O), S, SO₂, C(O)NH, C(O)O, O—C(O)—O, NH C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; and
the blend of any one of claims 1 to 6,
optionally in combination with one or more solvents and/or additives,
b) irradiating the mould at a wavelength ranging from 300 nm to 600 nm, preferably from 350 nm to 400 nm, or
b′) heating the mould at a temperature ranging from 60° C. to 250° C., preferably from 65° C. to 200° C.

11. A method for recycling a coating or a formed article, comprising the polymer adduct obtained by exposing a polymer (P1) to UV light at a wavelength ranging from 300 nm to 600 nm, wherein polymer (P1) comprises recurring units (R_{P1}) selected from the group consisting of poly(aryl ether sulfone) (PAES), poly(aryl ether ketone) (PAEK), poly(ether imide) (PEI) and polycarbonate (PC) and comprising at least one moiety (M1): 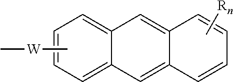
wherein:
W is a bond, O, C(O), S, SO₂, C(O)NH, C(O)O, O—C(O)—O, NH—C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; or
wherein the method comprises submitting the coating or formed article to UV irradiation at a wavelengths lower than 300 nm.

12. A method for recycling a coating or a formed article, comprising the polymer adduct of claim 7, by submitting the coating or formed article to heating at a temperature ranging from 100° C. to 500° C.

13. A recycled material obtainable by the method of claim 11 or 12.

14. A polymer (P1) comprising:
recurring units (R_{PPSU}) of formula (L-A): 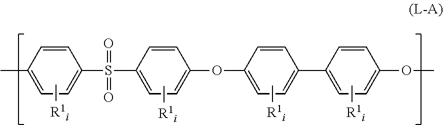
at least one moiety (M1): 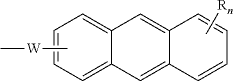
wherein:
each R¹ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is an integer independently selected from 0 to 4;
W is O, C(O), S, SO₂, C(O)NH, C(O)O, O—C(O)—O, NH—C(O)NH—, NH—C(O)—O, an imine-containing moiety or an imide-containing moiety;
R is a halogen atom or an alkyl group, optionally branched, preferably an C1-C18 alkyl group optionally substituted with one or several halogen atoms; and
n is 0 or an integer from 1 to 9, preferably 0; and

15. The polymer (P1) of claim 14, comprising at least one terminal group of formula (M-A): [chemical structure]
